(19) United States
(12) Patent Application Publication
(10) Pub. No.: US 2011/0047192 A1
(43) Pub. Date: Feb. 24, 2011

(54) DATA PROCESSING SYSTEM, DATA PROCESSING METHOD, AND PROGRAM

(75) Inventor: Naoki Utsunomiya, Machida (JP)

Correspondence Address: FOLEY AND LARDNER LLP;SUITE 500, 3000 K STREET NW, WASHINGTON, DC, 20007, US

(73) Assignee: Hitachi, Ltd.

(21) Appl. No.: 12/527,546

(22) PCT Filed: Mar. 19, 2009
(86) PCT No.: PCT/JP2009/001226

§ 371 Date: Aug. 17, 2009

(51) Int. Cl. G06F 17/30

(52) U.S. Cl. 707/809; 707/E17.044

(57) ABSTRACT

The present invention provides a mechanism for a plurality of archive servers to collaborate and archive data. To realize this, a data processing system (storage system including a data classification function) associates archive servers that manage data types, digitalizes values determined by corresponding archive products for the data belonging to the data types, determines that the determinations by the archive products are different when the difference between the values is large, and selects such data as a further archive target.

### TECHNICAL FIELD

The present invention relates to a data processing system, a data processing method, and a program, and for example, to data classification necessary for storage archiving and hierarchical management.

### BACKGROUND ART

In recent years, due to the increase in the amount of data handled by a business information system, the operation management cost of the data is considered a problem. Particularly, in addition to structured data stored as a database, the management of unstructured data handled as a file, represented by a document handled in the business information system, has been spotlighted. In recent reports, the rate of increase in the unstructured data is higher than the structured data, and the hierarchical management of file levels for arranging the unstructured data on appropriate storages in accordance with the service levels required for the unstructured data is needed.

In the hierarchical management of file levels, a storage hierarchy (primary storage device and secondary storage device) corresponding to the service levels (performance, accessibility, and reliability) is prepared, and files provided with the service levels are arranged in the storage of hierarchy corresponding to the service levels. Therefore, the files are usually classified based on the service levels, and the files are moved to appropriate storages when the files are not in the appropriate storages corresponding to the classification result. The storage of archive destination (archive storage) is also considered part of the hierarchical storage, and the archive is also considered part of the hierarchical storage management.

Therefore, it is important how to classify the files based on the service levels. For example, in the case of archiving, a retention period can be considered as a service level. In this case, considering the number of files and the like, it is unrealistic for the administrator, user, creator of the files, or the like to provide an appropriate retention period for each file, and the automatic setting of the retention period is an issue. Also in the case of general files, it is unrealistic to manually classify individual files based on the service levels, and the automatic classification is an issue.

In relation to the automatic classification, there are techniques of classification based on the frequency of words in a document as in Patent Document 1 and of classification into predetermined folders of a file system based on classification information from the user as in Patent Document 2. Furthermore, as in Patent Document 3, there is also a technique of classification of files based on attached information called metadata associated to the files. Furthermore, a research has been conducted to increase the search accuracy for search applications by using metadata, such as email, directory structure, and cache of browser, as semantic information (see Non-Patent Document 1).

An archive product such as Enterprise Vault of Symantec Corporation provides a function for moving data from a primary storage device to an archive storage in according with date, storage capacity, and the like, for each data type of files, email, and the like on NAS (Network Attached Storage). The user's setting can also control the movement under other conditions.
Patent Citation 1: U.S. Patent No. 2004-0083224
Patent Citation 2: U.S. Patent No. 2008-0027940
Patent Citation 3: JP Patent Publication (Kokai) No. 2008-146191A
Non Patent Citation 1: Paul A. Chirita et al., “Activity Based Metadata for Semantic Desktop Search”

### DISCLOSURE OF INVENTION

### Technical Problem

The conventional techniques and the current archive products independently control the archives for each managed data type. Therefore, archiving of email is performed only for the email, while archiving of files is performed only for the files. There is no association between the email and file archiving. In this case, there are problems described below. Although the problems are discussed herein with email and attached files as examples, the examples are not limited to these. The problems can also be considered in the relationship between a document file (NAS) and a document managed by document management server, a document managed by ECM (Enterprise Content Management), and the like.

First, a file attached to email archived by email archiving is not subjected to file archiving and may be left on the NAS. Thus, the condition determined by the email archiving is not efficiently used.

On the other hand, in relation to a file moved from the NAS to the archive storage, email attaching a file with the same content is not archived and may be left in the email server.

When there are a plurality of data types, such as files and email, not only does the data need to be arranged on optimal storages in terms of the individual data type, but the whole data need to be assembled and arranged on optimal storage in terms of all data types.

Furthermore, there is a management problem in which the administrator cannot monitor all files on the system that continue to increase. Therefore, in consideration of archiving and file management, an enormous amount of management cost is needed to check all files, weight the files, move the files to appropriate storages, and archive the files.

The management cost of archiving and hierarchical management can be reduced by limiting to certain data types. For example, in the case of archiving, the management cost is reduced by limiting to email, and dedicated software and archive management device automate the archiving.

However, the management cost for overall data including data other than the data types cannot be reduced. Even if a plurality of management devices as described above are prepared to reduce the overall management cost, there is a problem in the overall management, such as the evaluation criteria is different in each management device.

In the conventional techniques, a plurality of archive servers (for example, file servers and email servers) independently operate without collaboration. Therefore, there is no concept of discriminating between the data that should be archived with the collaboration by the plurality of archive servers and data that does not need to be archived with the collaboration.

The present invention has been made in view of the foregoing circumstances and provides a mechanism for archiving data with collaboration by a plurality of archive servers.

### Technical Solution

To solve the problems, a data processing system (storage system including a data classification function) associates archive servers that manage files of their own data types, digitalizes importance levels of the data belonging to the data types determined by archive products, determines that the determinations by the archive products are different if the difference of the resulting importance levels of the data is large, and selects such data as a further archive target.

Thus, a data processing system of the present invention comprises: a plurality of data servers (103, 114); a storage device (119) that aggregates and stores data stored in the plurality of data servers; a plurality of data migration devices (107, 118) that are arranged corresponding to the plurality of data servers (103, 114) and that move the data stored in the respective data servers (103, 114) to the storage device (119); and a management computer (108) that controls the plurality of data migration devices (107, 118) and that manages the movement of the data from the plurality of data servers (103, 114) to the storage device (119). The plurality of data servers (103, 114) include data at least partially having a predetermined correlation (for example, file and attached file of the email), among a plurality of types of data stored in the plurality of data servers (103, 114). The plurality of data migration devices (107, 118) respectively include data extracting units (130, 140) that respectively extract data satisfying predetermined filter conditions from the plurality of data servers (103, 114) and that send the data to the management computer (108). The management computer (108) manages the data that is extracted by the data extracting units (130, 140) and that is respectively stored in the plurality of data servers (103, 114) as data to be associated and moved to the storage device (119).

The plurality of data migration devices (107, 114) respectively include server monitoring units (131, 141). The server monitoring units (131, 141) monitor a predetermined event occurrence related to data stored in corresponding data servers. The management computer (108) further includes an importance calculating unit (110) and an information presenting unit (112). The importance calculating unit (110) calculates evaluation values of data extracted by the data extracting units (130, 140) based on a predetermined evaluation function at least including a time value evaluation when the server monitoring units (131, 141) detect the predetermined event occurrence in one of the plurality of data servers. The information presenting unit (112) compares and presents the evaluation values calculated by the importance calculating unit (110) in relation to the correlated data (for example, a file and email attaching the file).

More specifically, the data extracting units (130, 140) extract predetermined metadata from the extracted data and store the metadata in the metadata DBs (135, 145). In this case, the importance calculating unit (110) acquires the metadata corresponding to the extracted data (email and attached file) from the metadata DBs (135, 145) when the predetermined event occurrence is detected and calculates the evaluation values for each of the extracted data (set of email and attached file) based on the predetermined evaluation function.

More specifically, the information presenting unit (112) presents the evaluations to draw attention (for example, presenting in descending order of difference, or the display color of the data greater than a predetermined threshold value is varied from others) when the evaluation values of the data that is stored in the plurality of data servers and that includes a predetermined correlation have a difference of more than a predetermined absolute value (threshold) from an average value of the evaluation values of the data. If there is a difference greater than the threshold, it is likely that the data (a file and email attaching the file) including a predetermined condition is provided with different evaluations by the data migration devices and is managed in different storage levels (one is on the server, and the other is on the archive storage).

The present system further comprises a policy engine (1910) that verifies a prepared policy including a condition section describing conditions and an action section describing an action executed when the conditions are satisfied. The policy engine (1910) compares the predetermined metadata and the evaluation value with the policy for each of the data and controls the plurality of data migration devices (107, 118) to execute the action when all the conditions are satisfied.

Further features of the present invention will become apparent from the best mode for carrying out the invention and the appended drawings.

### ADVANTAGEOUS EFFECTS

According to the present invention, data managed independently by different servers are associated to realize the hierarchical storage management. Therefore, the efficient storage management of the entire system can be performed. The management cost of the system administrator checking all files to perform the hierarchy storage management can also be reduced. Furthermore, a uniform management standard can be applied to the entire system.

### BRIEF DESCRIPTION OF THE DRAWINGS

FIG. 1 is a diagram of a schematic configuration of a data classification processing system according to a first embodiment of the present invention.

FIG. 2 is a diagram for explaining a processing outline of the present invention.

FIG. 3 is a diagram for explaining an outline of a process of an email archive server of the present invention.

FIG. 4 is a diagram of details of an email metadata table (example).

FIG. 5 is a diagram of details of an email monitoring table (example).

FIG. 6 is a diagram of details of an NAS metadata table (example).

FIG. 7 is a diagram of details of an NAS monitoring table (example).

FIG. 8 is a diagram of details of an email metadata DB (example).

FIG. 9 is a diagram of details of a file metadata DB (example).

FIG. 10 is a flow chart for explaining a metadata filtering process in an email archive server.

FIG. 11 is a flow chart for explaining a metadata filtering process in an NAS archive server.

FIG. 12 is a flow chart for explaining an evaluation process in an importance calculating unit.

FIG. 13 is a diagram of details of an importance DB (example).

FIG. 14 is a diagram of an example of an evaluation formula related to email.

FIG. 15 is a diagram of an example of an evaluation function related to elapsed time.

FIG. 16 is a diagram of an example of an evaluation formula related to file.

FIG. 17 is a diagram of evaluation results of use cases (example).

FIG. 18 is a diagram of a display example in an important file display unit.

FIG. 19 is a diagram of a schematic configuration of a data classification processing system (collaboration with hierarchical storage management) in a second embodiment.

FIG. 20 is a flow chart for explaining an evaluation process of the importance calculating unit in the data classification processing system according to the second embodiment.

FIG. 21 is a diagram of a policy example of hierarchical storage management.

FIG. 22 is a diagram of a schematic configuration of the data classification processing system (dispersion assessment) according to a third embodiment.

FIG. 23 is a flow chart for explaining a server monitoring process in the email archive server.

FIG. 24 is a flow chart for explaining a server monitoring process of the NAS archive server.

### EXPLANATION OF REFERENCE

101 . . . LDAP server, 126 . . . network, 103 . . . email server, 106 . . . metadata extracting unit in email archive server, 107 . . . email archive server, 108 . . . management computer, 109 . . . metadata collecting unit in management computer, 110 . . . importance calculating unit in management computer, 111 . . . importance DB in management computer, 112 . . . important file presenting unit in management computer, 113 . . . policy acquisition unit in management computer, 114 . . . NAS, 117 . . . metadata extracting unit of NAS archive server, 118 . . . NAS archive server, 130 . . . metadata filtering unit of email archive server, 131 . . . server monitoring unit of email archive server, 132 . . . search unit of email archive server, 133 . . . metadata table of email archive server, 134 . . . monitoring table of email archive server, 135 . . . metadata DB of email archive server, 140 . . . metadata filtering unit of NAS archive server, 141 . . . server monitoring unit of NAS archive server, 142 . . . search unit of NAS archive server, 143 . . . metadata table of NAS archive server, 144 . . . monitoring table NAS archive server, 145 . . . metadata DB of NAS archive server, 1901 . . . hierarchical storage management policy, 1902 . . . archive policy engine of email archive server, 1903 . . . archive policy engine of NAS archive server, 1921 . . . hierarchical storage management device, 2201 . . . importance collecting unit, 2202 . . . importance calculating unit of email archive server, 2203 . . . importance calculating unit of NAS archive server

### BEST MODE FOR CARRYING OUT THE INVENTION

The present invention relates to a data classification processing system configured to extract data that a plurality of archive servers should collaborate and manage and to manage a plurality of data at the same evaluation criteria.

Embodiments of the present invention will now be described with reference to the appended drawings. It should be noted that the present embodiments are only examples for realizing the present invention and do not limit the technical scope of the present invention. The common configurations in Figures are designated with the same reference numerals. Although an example of collaboration (sharing of metadata) of an email archive server and an NAS archive server is described in the embodiments below, the arrangement is not limited to this. The embodiments can be applied to a combination of a document management archive server and an NAS archive server and to other combinations, and the number of archive servers may be more than two.

### (1) First Embodiment

<Configuration of Data Classification Processing System>

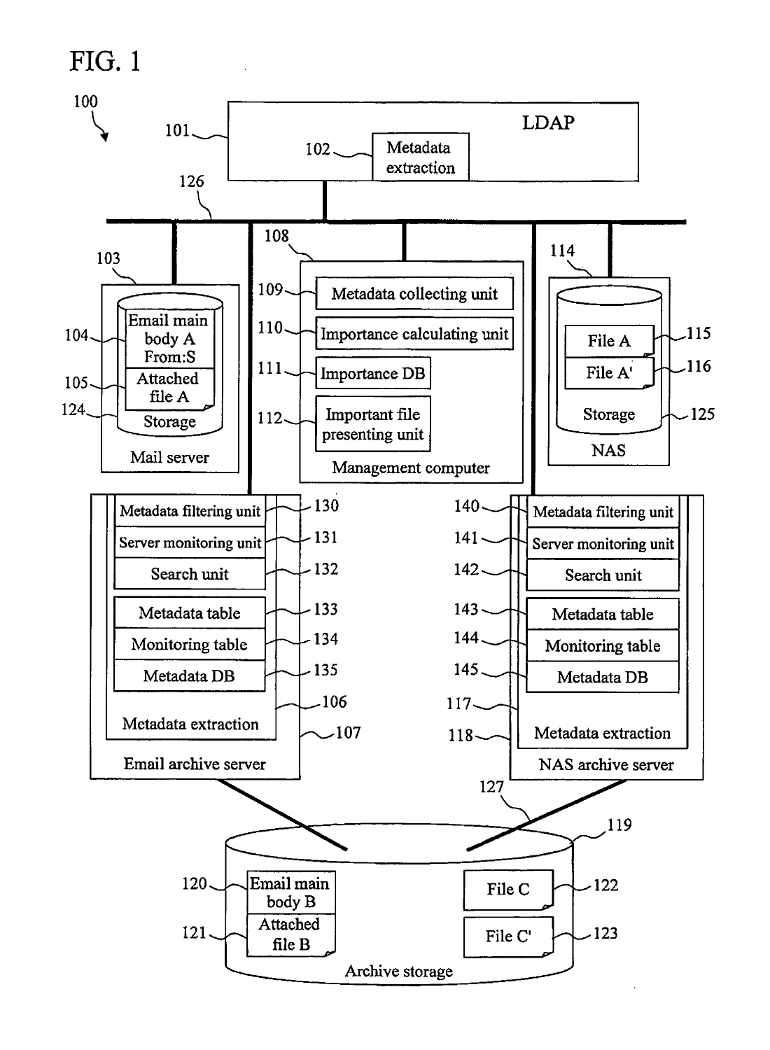

FIG. 1 is a diagram of a schematic configuration of a data classification processing system (data processing system) 100 according to a first embodiment of the present invention. Data types to be archived herein are email (Email) and files (including attached files of email).

The data classification processing system 100 comprises an LDAP (Lightweight Directory Access Protocol) server 101, a mail server 103, an NAS 114, a management computer 108, an email archive server 107, an NAS archive server 118, and an archive storage 119, which are connected through a network 126. The email archive server 117 and the NAS archive server 118 are connected to the archive storage 119 as a storage for storing data to be archived through a fiber channel 127.

Email of the client is aggregated to the mail server 103 and stored in a storage 124 managed by the mail server 103. The email archive server 107 monitors the operation of the mail server 113 and moves the email from the storage 124 of the mail server to the archive storage 119 in accordance with a preset condition.

The files are aggregated to the NAS 114 and stored in the storage 125 managed by the NAS 114. The NAS archive server 118 monitors the operation of the NAS 114 and moves the files from the storage 125 of the NAS to the archive storage 119 in accordance with a preset condition.

The management server 108 comprises a metadata collecting unit 109, an importance calculating unit 110, an importance DB 110, and an important file presenting unit 112. The metadata collecting unit 109 sets up the configuration of metadata acquired for the archive servers and takes up the acquired metadata to a management computer. The importance calculating unit 110 evaluates the data of each archive server in accordance with a given formula. The importance DB 111 stores evaluation results calculated by the importance calculating unit 110. The important file presenting unit 112 presents the content of the importance DB to the system administrator.

The archive servers 107 and 118 include metadata extracting agents 106 and 117, respectively. The email archive server 107 includes the metadata extracting agent 106. The metadata extracting agent 106 is constituted by a metadata filtering unit 130, a server monitoring unit 131, a search unit 132, a metadata table 133, a monitoring table 134, and a metadata DB 135. Similarly, the NAS archive server 118 includes the metadata extracting agent 117. The metadata extracting agent 117 is constituted by a metadata filtering unit 140, a server monitoring unit 141, a search unit 142, a metadata table 143, a monitoring table 144, and a metadata DB 145.

The metadata filtering units 130 and 140 acquire metadata based on the setting set by the management computer 108 and store the metadata in the metadata DBs 106 and 145. The setting of the acquired metadata is recorded in the metadata tables 133 and 143. The server monitoring units 131 and 141 monitor operations of the archive servers. Monitoring conditions are recorded in the monitoring tables 134 and 144. The search units 132 and 142 search data to be managed by the archive servers 107 and 118.

<System Operation Outline>

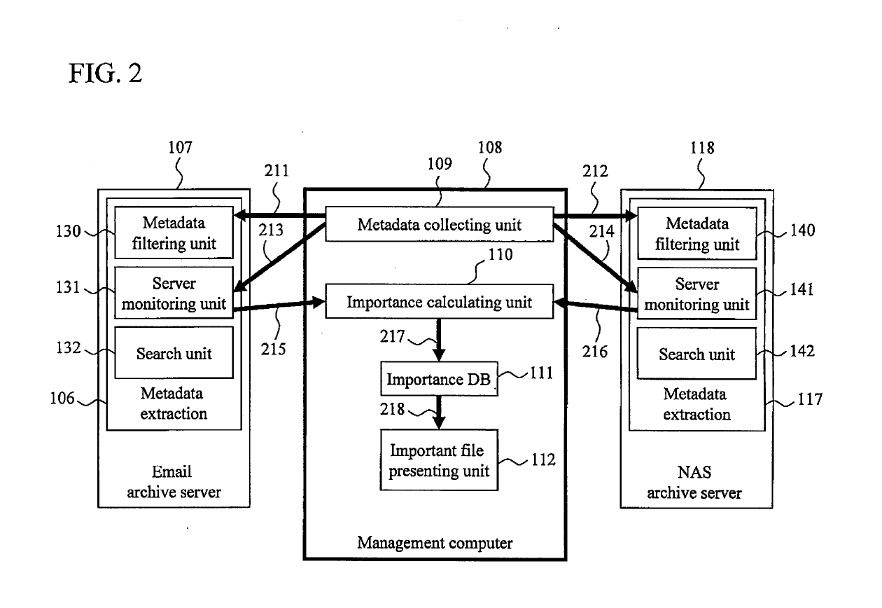

FIG. 2 is a diagram for explaining an operation outline (entire process) of the data classification processing system of the present embodiment. The overall major processes are constituted by a filter setting process, a monitor setting process, an importance calculation process, and an importance presenting process. The metadata collecting unit (109) executes the filter setting process, the importance calculating unit (110) executes the importance calculation process, and the important file presenting unit (112) executes the importance presenting process. In addition to the processes, there are a metadata filtering process and a server monitoring process.

The metadata collecting unit 109 of the management computer 108 sets metadata necessary to be focused as a monitoring target to the metadata filtering units 130 and 140 on the email archive server 107 and the NAS archive server 118 in accordance with an input instruction of the administrator (processes 211 and 212). For example, in relation to the email archive server 107, the metadata collecting unit 109 informs the metadata extracting agent 106 that the sender, transmission date, attached file, and the like are focused as the metadata. As a result of the setting process, the metadata extracting agent 106 can determine that email without attached files will be unmanaged. Therefore, the email archive server 107 moves the unmanaged emails to the archive storage independently from (without collaboration with) the NAS archive server. Thus, the metadata filtering units 130 and 140 extract the managed data.

In relation to the metadata filtering process, the metadata filtering units 130 and 140 monitor resources managed by the email server and the NAS server, respectively, and select metadata to be extracted from the resources. More specifically, metadata suitable for a filter condition specified by the administrator is selected, and a state (value) of the metadata is recorded when there is a change in the state (value) of the selected metadata.

The metadata collecting unit 109 sets monitoring conditions to the server monitoring units 131 and 141 of the archive servers 107 and 118 (processes 213 and 214). Examples of the monitoring conditions include “sender is a specific email address” and “file is archived”. After the monitoring condition setting, the present system starts operating. The metadata extracting agents (metadata monitoring agents) 106 and 117 monitor operations of the email server 103 and the NAS 114, filter email and files, and store information of the extracted email and files to the metadata DB.

The metadata extracting agents 106 and 117 of the archive servers generate an event when set monitoring conditions are satisfied and informs the fact of the event generation to the importance calculating unit 110 of the management computer 108 (processes 215 and 216). The importance calculating unit 110 is activated along with the generation of event and receives the stored information from the metadata extracting agents 106 and 117.

The importance calculating unit 110 then calculates the importance of the data (email or files) indicated by the received information, based on formulas of the data types specified in advance, and stores the result in the importance DB 111 (process 217).

When the administrator issues a command, the data in the importance DB 111 is displayed on a console for the administrator (process 218). The administrator looks at and checks the displayed data and can eventually determine whether to perform archiving.

Further details of the processes will be described below.

<Configuration of Email Archive>

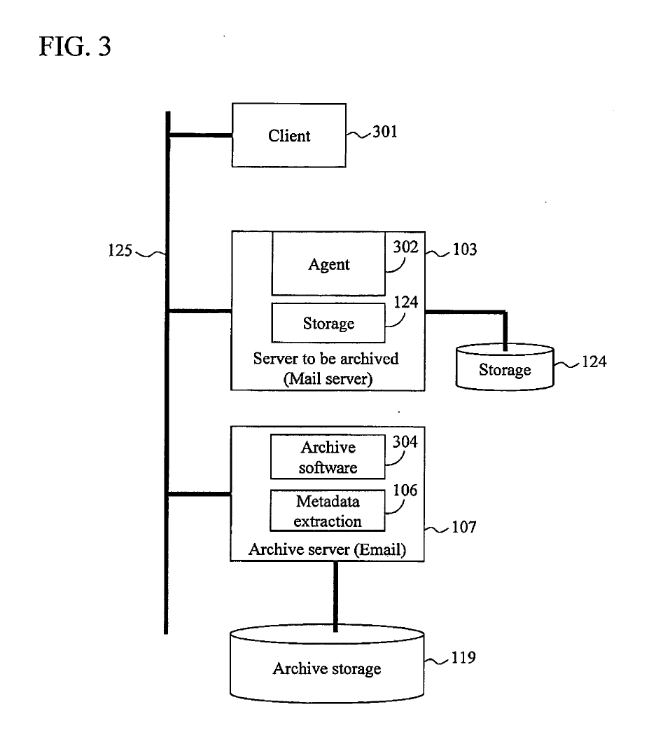

FIG. 3 is a diagram of a configuration of email archiving before metadata extracting agents for associating the archive servers are installed on the archive servers. As shown in FIG. 3, a plurality of email clients 301, the server 103 that provides email services, and the email archive server 107 that transfers data on the server to the archive storage 119 are connected to the network 125. The archive storage 119 is connected to the email archive server 107. Furthermore, the storage 124 used for data store is connected to the email server 103.

An agent 302 for the email archive server 107 to monitor operation of the email server operates on the email server 103. The agent 302 may not be doployed if the email server 103 can monitor the email server from outside through the network 125.

Archive software 304 operates on the email archive server 107. The archive software 304 monitors the email server 103 and checks the stored email if a predetermined time interval has passed or a stored email capacity of the storage 124 for storing email exceeds a threshold. The archive software 304 further selects email according to predetermined criteria and moves the email to the archive storage 119. An example of the determination criteria includes the oldness of email, and the archive software 304 selects those emails whose transmission date of email is out of a certain period from the current time.

Although the configuration before the installment of the metadata extracting agent of the NAS archive on the archive server is not illustrated, the configuration is the same as in FIG. 3.

<Content of Email Metadata Table>

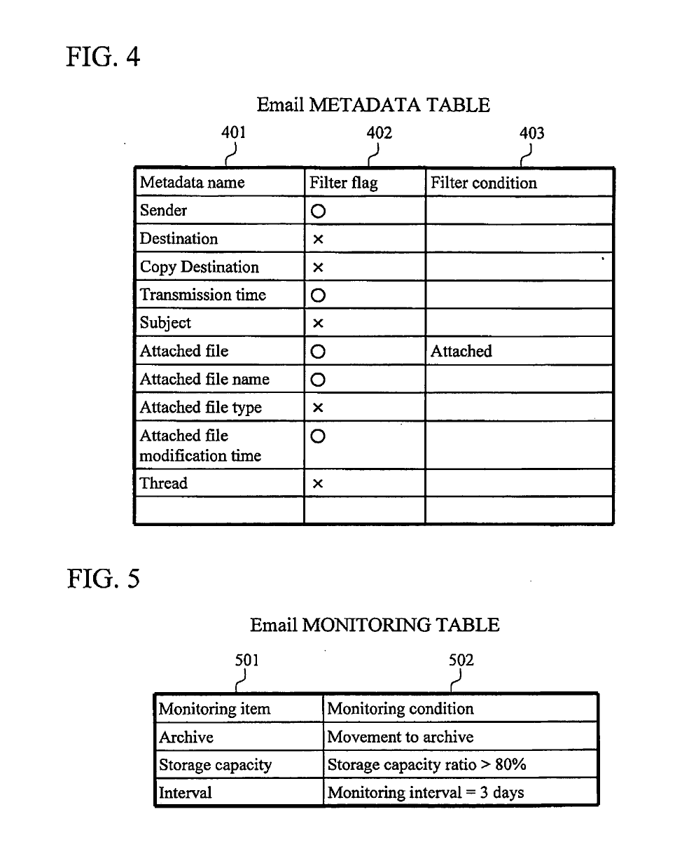

FIG. 4 is a diagram of details of the metadata table 133 held by the metadata extracting agent 106 of the email archive server 107.

The metadata table 133 includes metadata name, filter flag, and filter condition. Metadata that can be handled by the email archive server is written in a metadata name field 401. A filter flag 402 indicates whether data in the metadata 401 are used for filtering. Thus, according to a table example of FIG. 4, it can be seen that sender, transmission time, attached file, attached file name, attached file modification time are used for filtering. Conditions for filtering are written in a filter condition 403. According to the example of the table of FIG. 4, a filter condition is set to an attached file, indicating that email with attached files will be selected.

<Content of Email Monitoring Table>

FIG. 5 is a diagram of details of the monitoring table 134 of the email archive server 107. The monitoring table 134 includes a monitoring item 501 and a monitoring condition 502. The monitoring conditions can be set by combining logical operations of the monitoring items (at least one monitoring item is needed). The monitoring condition 502 can be expressed by predetermined monitoring conditions or evaluation formulas using metadata values. For example, “MOVEMENT TO ARCHIVE” as a monitoring condition set in the “ARCHIVE” item of FIG. 5 indicates a predetermined monitoring condition, and the condition is satisfied when the email moves to the archive storage. “STORAGE CAPACITY RATIO” and “MONITORING INTERVAL” are also predetermined monitoring conditions, which indicate a data occupancy capacity ratio of storage for storing email and a monitoring interval, respectively. An example of evaluation using a value of metadata includes specifying “subject=‘*warning*’”. In this case, the monitoring item is satisfied when the subject of email includes the word “warning”.

When all monitoring conditions, in which the monitoring items are combined by logical operators, are satisfied, an event occurs. The server monitoring unit 131 informs the event to the management computer (management server) 108.

<Content of NAS Metadata Table and Monitoring Table>

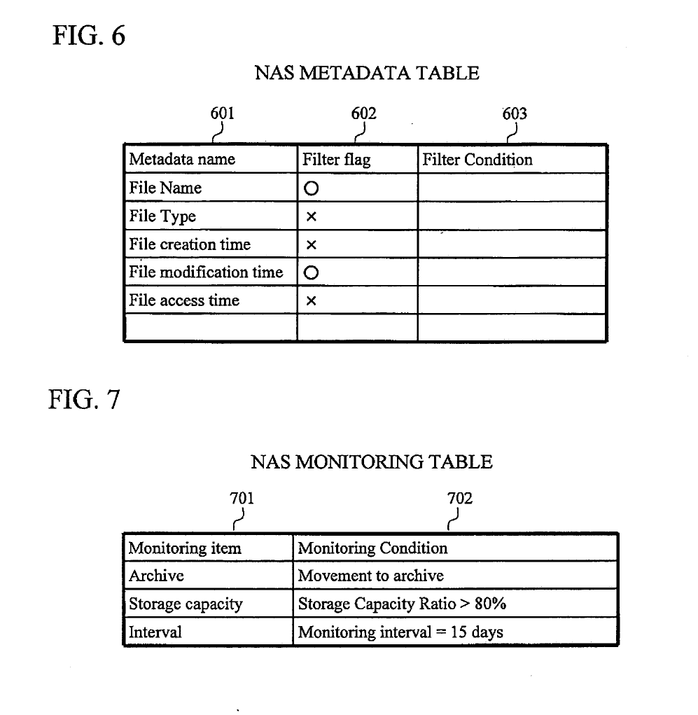

FIGS. 6 and 7 are diagrams of details of the metadata table 143 and the monitoring table 144 in the NAS archive server 118. Although corresponding metadata names are different, the basic configuration is the same as the configuration held by the email archive server.

<Content of Email and NAS Metadata DBs>

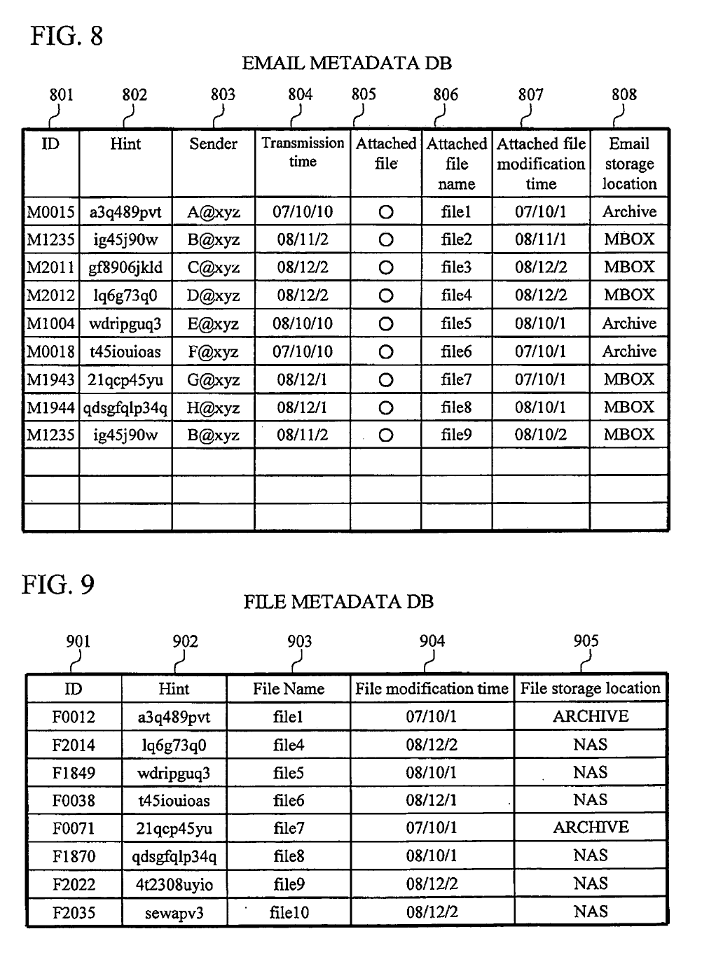

FIG. 8 is a diagram of details of the metadata DB 135 held by the email archive server 107. An identifier (ID) 801 and a hint 802 are assigned to the stored metadata. The hint 802 is a hash value of an attached file. The hash value is obtained based on the content of the attached file and indicates hint information for the content of the attached file. Thus, if the contents of two attached file are equal, the hash values are the same values. However, hash values of two attached files being the same does not always indicate that the contents of the attached files are equal.

Therefore, to determine whether the contents of two attached files are equal, the values of the corresponding hash values are first checked, and the attached files are determined different if the values are different. If the values are equal, the contents of the files are further compared to obtain a conclusion.

Items 803 to 808 following the hint 802 are metadata selected in the metadata table 133 (FIG. 4). The metadata DB 135 holds information related to the metadata of email selected in accordance with the filter conditions specified in the metadata table 133.

FIG. 9 is a diagram of details of the metadata DB 145 held by the NAS archive server. Although the fields of the metadata are different from those in FIG. 8 (email metadata DB), the basic configuration is the same as in the case of email. As in FIG. 8, hash values of files are entered into the hint column.

<Details of Filtering Process>

The filter setting process is a process of setting the filter conditions in the archive servers 107 and 118 in response to an instruction inputted by the administrator, as described above. The setting of the conditions is constituted by a designation of metadata of email whose values will be stored and a designation of filtering conditions using the metadata.

The metadata to be stored in the email archive server 107 includes sender, transmission time, attached file, attached file name, and attached file modification time. When the metadata is specified, the corresponding filter flag 402 of the email metadata table of FIG. 4 is marked with “O (yes)”. Since the filter condition indicates that only the email with attached files is extracted, “ATTACHED FILE” is set as metadata, and “EXIST” is set as a filter condition. As a result, the filter condition 403 corresponding to the metadata “ATTACHED FILE” of the email metadata table is set to “EXIST (ATTACHED)”.

For the NAS archive server 118, the file name and the file modification time are set as the metadata to be stored. As a result, a corresponding filter flag 602 of the NAS metadata table of FIG. 6 is marked with “O (yes)”. The filter condition is not particularly specified for the NAS archive server 118. Therefore, all files are targets of filtering in this case.

The archive server monitoring process is a process of monitoring operations of the archive servers 107 and 118. Based on a preset monitoring condition, the server monitoring units 131 and 141 inform an event to the management computer 108 when the archive server satisfies the condition. The server monitoring unit of the archive server executes the archive server monitoring process.

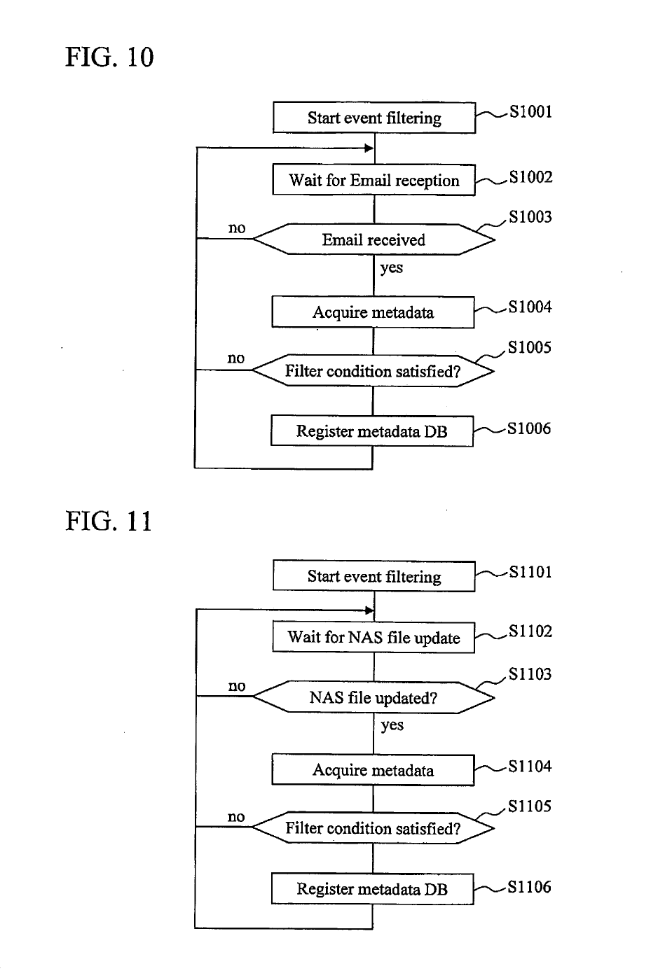

Next, details of the metadata filtering process in the archive servers 107 and 118 will be described using FIGS. 10 and 11.

FIG. 10 is a flow chart for explaining the metadata filtering process in the email archive server 107. The metadata filtering process starts when the email archive server 107 is activated (step S1001). The archive software 304 waits to receive email (step S1002) and determines whether email has arrived (step S1003). If email has not arrived, the archive software 304 again waits to receive email (step S1002).

If email has arrived, the metadata filtering unit 130 refers to the email metadata table 133 to extract necessary metadata from the arrived email (step S1004). Metadata that should be acquired based on the filter setting is written in the email metadata table 133. Specifically, sender, transmission time, attached file, attached file name, and attached file modification time are collected as the metadata (see FIG. 4).

The metadata filtering unit 130 then checks the filter condition to determine whether to store the acquired metadata (step S1005). Specifically, since “ATTACHED” is set as a filter condition in the item of attached file on the email metadata table 133, whether there is an attached file is checked. If there is an attached file, the filter condition is satisfied, and the process proceeds to step S1006. If there is no attached file, the metadata filtering unit 130 abandons the acquired metadata. The process then returns to step S1002 and again waits to receive email.

When the filter condition is satisfied, the metadata filtering unit 130 registers the acquired metadata in the metadata DB 135 (step S1006). The process then moves to step S1002 and waits to receive email.

FIG. 11 is a flow chart for explaining the metadata filtering process in the NAS archive server 118. The metadata filtering process starts when the NAS archive server 118 is activated (step S1101). Archive software (not shown) for NAS archive waits for the update of file on the NAS (step S1102) and determines whether a file is updated (step S1103). If there is no update, the archive software again waits for the update of file (step S1102). If a file is updated, the metadata filtering unit 140 refers to the NAS metadata table 143 and extracts necessary metadata from the updated file (step S1104). Metadata that should be acquired based on the filter setting is written in the NAS metadata table 143. Specifically, file name and file modification time are collected as the metadata (see FIG. 6).

The metadata filtering unit 140 checks the filter condition to determine whether to store the acquired metadata (step S1105). Since the filter condition is not written on the NAS metadata table 143, all files satisfy the filter condition. Therefore, the filter condition is always satisfied in the present embodiment, and the process moves to step S1106. If a filter condition is set and the filter condition is not satisfied, the metadata filtering unit 140 abandons the acquired metadata. The process returns to step S1102 and again waits for the update of file.

If the filter condition is satisfied, the metadata filtering unit 140 registers the acquired metadata in the metadata DB (step S1106). The process then moves to step S1102 and waits for the update of file.

<Details of Monitor Setting Process>

The monitor setting process is a process of setting a monitoring condition in the archive servers 107 and 118 and is realized by selecting the monitoring items and designating the items.

The following condition is set for the email archive server 107. That is, (A) “email is moved to archive”; or (B) “email storage capacity ratio on email server exceeds 80%”; or (C) “three days of monitoring interval has expired”. After the setting, the email monitoring table is constituted as shown in FIG. 5. A condition of a combination of a plurality of items can also be set. Although the condition is “(A) or (B) or (C)” in the above case, a condition such as “(A) and ((B) or (C))” can also be set. The condition is also set to the NAS archive server 118 in the same way (see FIG. 7).

In the archive servers 107 and 118, the server monitoring units 131 and 141 operate the monitoring process related to the monitoring items set in the monitoring tables 134 and 144 to monitor the archive servers 107 and 118. In the present embodiment, the server monitoring unit 131 on the email archive server 107 monitors based on the conditions (A), (B), and (C). Since “(A) or (B) or (C)” is set herein, the server monitoring unit 131 generates an event and transmits the event to the management computer 108 at the same time when, for example, the email archive server 107 moves the email on the email server 103 to the archive storage 119. The same applies when the condition (B) or (C) is satisfied.

The server monitoring unit 141 on the NAS archive server 118 also operates in the same manner.

<Importance Calculation Process>

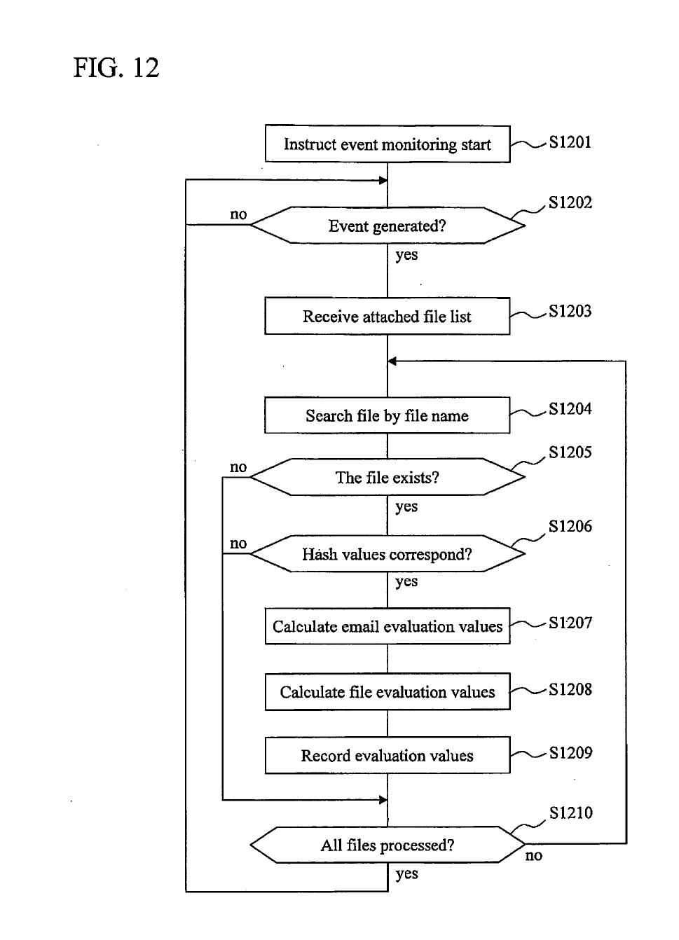

FIG. 12 is a flow chart for explaining an operation of the importance calculation process in the importance calculating unit 110 of the management computer 108. It is assumed in the present embodiment that an event is informed from the email archive server 107.

First, when the archive servers 107 and 118 are activated, the management computer 108 instructs the start of the monitoring process to the archive servers 107 and 118 as target of the importance calculation process (step S1201). This starts monitoring of the archive servers based on the preset monitoring condition.

The importance calculating unit 110 then checks whether there is an event generation from the archive server 107 or 118 (step S1202). If the monitoring condition is satisfied in the archive server 107 or 118, the event is informed to the importance calculating unit 110 of the management computer 108. If the event is not generated, the process returns to step S1202 and waits for the event.

If there is an event generation, the importance calculating unit 110 issues a request to the email archive server 107 to acquire a list of files attached to the email (step S1203). The email archive server 107 that has received the acquisition request of the attached file list transmits information of the files registered in the metadata DB 135 to the importance calculating unit 110 as an attached file list along with the information of the metadata.

The importance calculating unit 110 then executes the following calculation process to the individual files in the attached file list. The importance calculating unit 110 first designates the file name of the attached file as a key to search the file on the NAS and calls the search unit 142 on the NAS archive server 118 to search the file (step S1204). The search unit 142 on the NAS archive server 118 searches the file by arbitrary search means with the file name as a key.

If the file is found, the search unit 142 searches the file metadata DB 145 to acquire metadata corresponding to the obtained file. If the acquisition of the corresponding metadata is successful, the search unit 142 attaches the hash value of the hint information on the DB to the search result and returns the result to the importance calculating unit 110. If the file does not exist on the NAS as a result of the search, the evaluation value is not calculated, and the process moves to step S1210 (step S1205). If the file corresponding to the file name exists on the NAS, a plurality of files (referred to as search result file) on the NAS are returned as a search result.

For each of the plurality of search result files, the importance calculating unit 110 compares the hash value corresponding to the search result file in the search result and the hash value of the email metadata DB 145 attached to the file list (step S1206). If the hash values are different, the comparison process is executed for the next search result file. If the hash values are equal, a comparison process of the contents is executed to check that the content of the file is the same. The process proceeds to step S1210 if the contents of all the plurality of search result files are not equal to the contents of the attached files, that is if it is found that the hash values are not equal or the contents are not equal in the comparison of the contents.

If the contents are equal, the importance calculating unit 110 calculates the evaluation value of the email corresponding to the attached file (step S1207).

After calculating the evaluation value of the email, the importance calculating unit 110 calculates the evaluation value of the file (step S1208).

The importance calculating unit 110 then records the calculated result in the importance DB 111 (step S1209) and determines whether the process is executed for all files in the list (step S1210). If the process is completed for all files, the process again returns to step S1202 and waits for the generation of the next event. If the process is not completed for all files in the list, the process returns to step S1204, and the importance calculating unit 110 executes the processes of steps S1204 to S1209 for the next file in the list.

To further facilitate understanding, the importance calculation process will be described with a specific example. It is assumed that only the monitoring interval is valid among the monitoring conditions (FIG. 5) of the email archive server 107. Since the monitoring period of three days has passed, the generation of event is informed to the management computer 108. If there is a generation of event, the importance calculating unit 110 acquires information of the attached file that the email archive server 107 has extracted from the information of email stored in the metadata DB 135 (equivalent to the process of step 1203). In this case, attached files with the file names file1 to file9 and metadata (ID, sender, transmission time, attached file modification time, and email storage location) corresponding to the files are formed into a list, and the list is transmitted to the importance calculation processing unit 110. The constituent elements of the list of the attached files include files with file names file1, file2, file3, file4, file5, file6, file7, file8, and file9.

The search unit 142 then searches the files in the file list on the NAS with the file name as a key (equivalent to the process of step S1204). It is assumed herein that the file1, file4, file5, file6, file7, file8, and file 9 are found on the NAS as a result of the search. Since the data of all the files exists in the file metadata DB 145 on the NAS, the hash values of hint information are attached to the entire search result. For example, a hash value “a3q489pvt” is attached to the file1 in the search unit 142. This hash value and the hash value of the attached file in the attached file list are compared (equivalent to the process of step S12106). In the case of the file1, a hash value “a3q489pvt” in the hint information corresponding to email M0015 of the email metadata DB is attached to the attached file list. This value and the hash value in the search result are compared. As the values are equal, the files are acquired from the email server 103 and the NAS 114 to compare the contents bit by bit. If it can be confirmed that the contents are equal as a result of the comparison, the process proceeds to the next evaluation value calculation.

The importance calculating unit 110 calculates the evaluation value of the email corresponding to the file (equivalent to the process of step S1207). For example, in the case of the file1, since the corresponding email is email with an ID M0015, the evaluation value of the M0015 is calculated. The importance calculating unit 110 then calculates the evaluation value of the file (step S1208). Thus, the evaluation value of the file with the file name file1 is calculated.

Subsequently, the importance calculating unit 110 records both calculation results in the importance DB 111 (equivalent to the process of step S1209). Similarly, the evaluation values of email M2012, M1004, M0018, M1943, M1944, and M1976 which are email corresponding to the files file4 to file9 are calculated, and at the same time, the evaluation values of the files file4 to file9 are calculated. Both evaluation values are recorded in the importance DB 111.

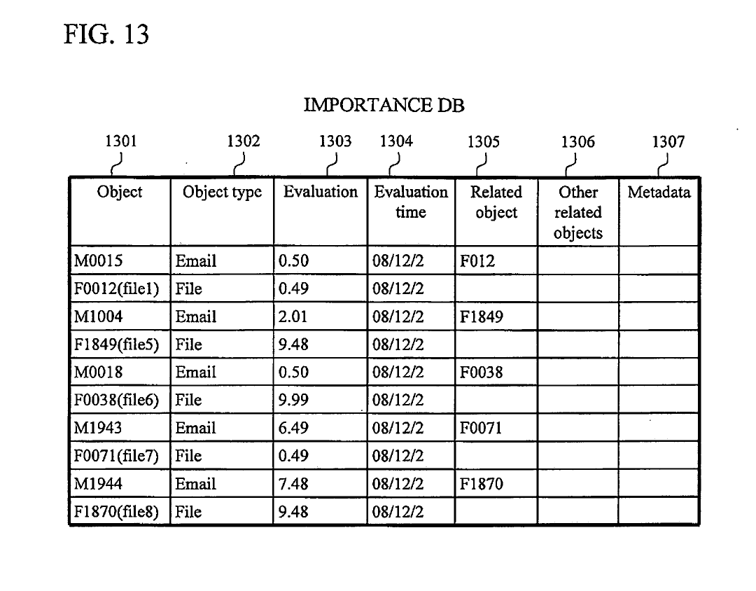

The calculation result recorded in the importance DB 111 is as shown in FIG. 13. The evaluation value of the email of M0015 is 0.50, and the simultaneously evaluated evaluation value of the file F0012 is 0.49. The same applies for the third row and below.

<Importance Evaluation Formula>

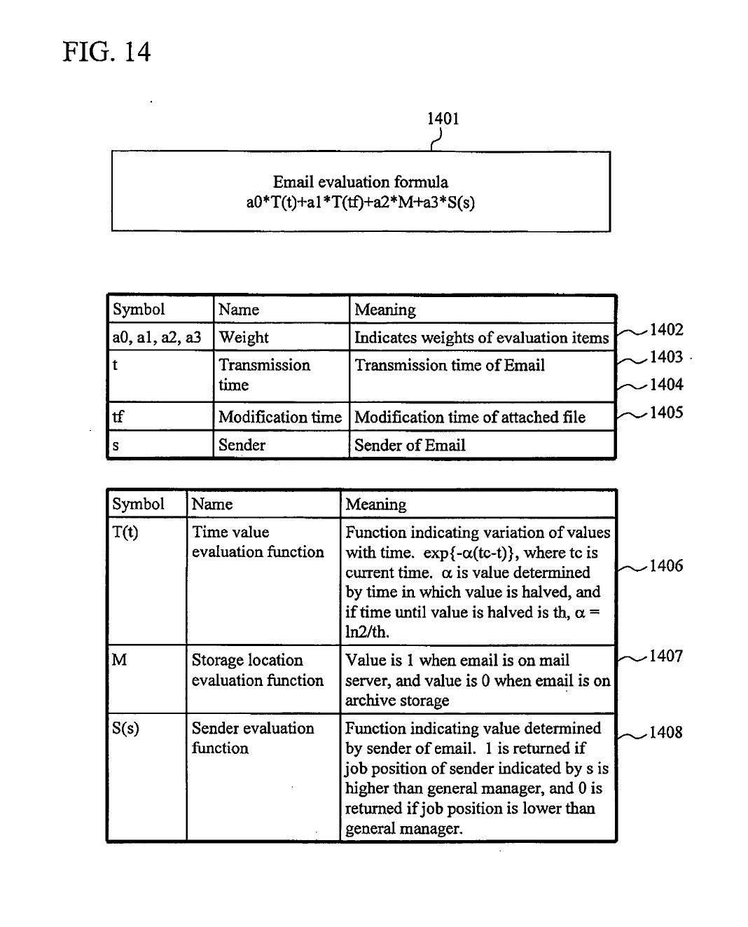

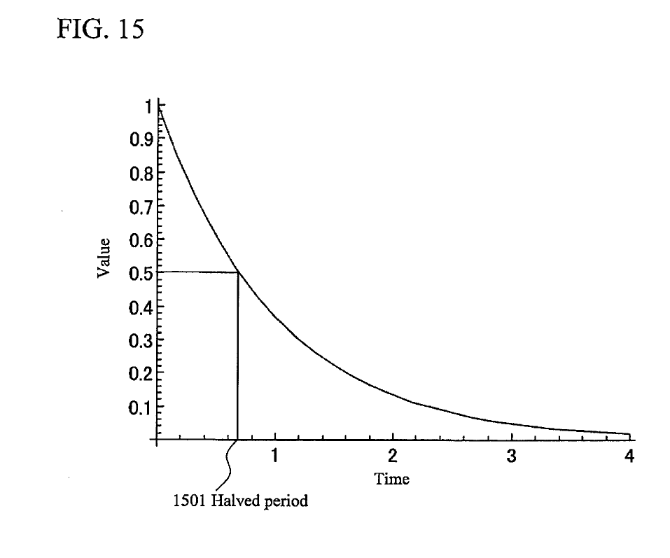

FIG. 14 shows an importance evaluation formula 1401 related to email in the present embodiment. The importance evaluation formula 1401 is expressed in a combination of metadata, primitive functions, and weights. In the importance evaluation formula 1401, a transmission time 1403, an attached file modification time 1404, and a sender 1405 are used as the metadata.

A time value evaluation function 1106, a storage location evaluation function 1107, and a sender evaluation function 1108 can be considered as required primitive functions. However, the primitive functions are not limited to these. In the present embodiment, the evaluation formula is realized by the sum of the terms of the combination of the metadata, the primitive functions, and the weights. The first term denotes evaluation of the transmission time of email, and the second term denotes evaluation of the modification time of the attached file. The third term denotes evaluation of the storage location. The last term denotes evaluation of the sender of email.

Therefore, the evaluation formula means: the more the elapsed time from the transmission time of email, the lower the value of the email; the more the elapsed time from the modification time of the file attached to email, the lower the value of the email; when email is moved to the archive storage, the value lowers; and the value of email is determined by the job position of the sender.

A primitive function prepared by the importance calculating unit 110 is used to realize the meaning. FIG. 15 shows a graphic display of the time value evaluation function 1406. The vertical axis denotes value, and the horizontal axis denotes time. The function is expressed by a formula y=exp{−x}, where y denotes the vertical axis, and x denotes the horizontal axis. The time of the horizontal axis denotes a value of the current time minus the time of evaluation target, which indicates an elapsed time. For example, if the transmission time of email is the evaluation target, a value of the current time minus the transmission time is appropriately normalized to obtain the value of the time of the horizontal axis.

The normalization is performed as follows. The time 1501 when the value is halved in the graph of FIG. 15 is considered. In the case of the graph y=exp {−x}, this time is ln2, or about 0.69. The time that the value is halved is provided, and the scale is appropriately converted to obtain a time value evaluation function. Specifically, if the time that the value of email is halved is a half year (=th), the time value evaluation function reflecting this is T(t)=exp{−alpha(tc−t)}, where alpha=ln2/th. If the unit of time is the number of days, alpha is about 0.0038.

The value of a storage location evaluation function (M) 1407 is 1 when email is on the email server and is 0 when email is on the archive storage. This indicates that the value of email on the email server is high, and the value of email on the archive storage is low. The value of a sender evaluation function S(s) is 1 when the job position of the sender of email, which is given as an argument to the sender evaluation function, is general manager or higher and is 0 when the job position is lower than general manager. This indicates that the value of email from a person high in the job position is high.

The primitive functions are combined to define the evaluation formula of email as 1401. Here, a0, a1, a2, and a3 denote weights, t denotes transmission time of email, tf is modification time of attached file, and s denotes sender of email. It is assumed that the value of evaluation formula is 0 to 10, and the values of the weights are determined so that the evaluation result should be within the range. Higher values are more valuable.

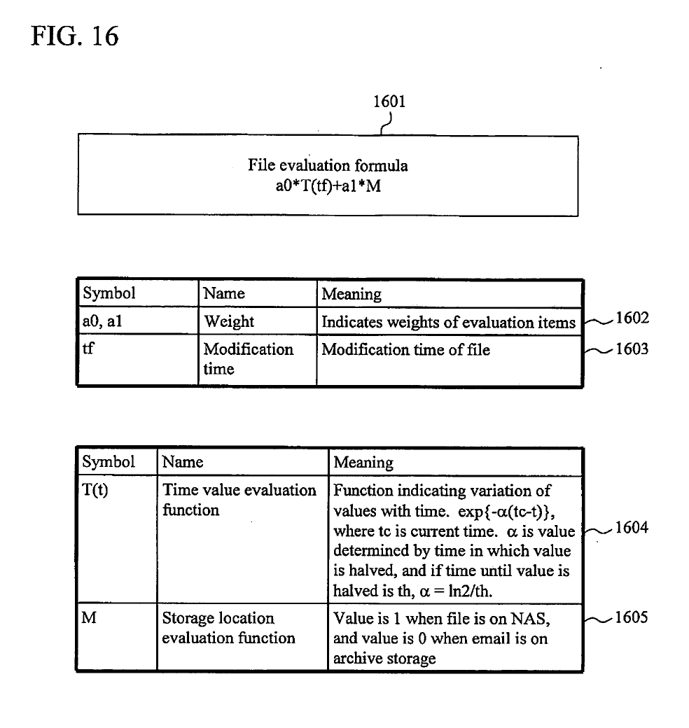

FIG. 16 shows an importance evaluation formula 1601 related to files on the NAS in the present embodiment. The meanings of the symbols are substantially the same as in the case of email. The present formula indicates that the more the elapsed time from the modification time of file, the lower the value of file, and the value lowers when the file is moved to the archive storage.

<Evaluation Result>

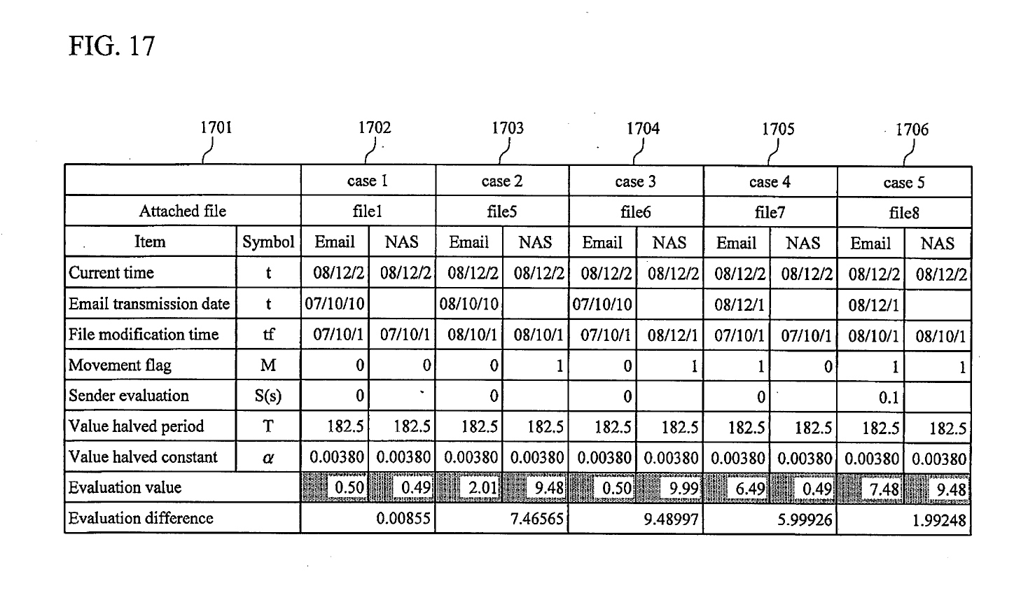

FIG. 17 is a diagram of a result of evaluation of email and files based on the importance evaluation formulas 1401 and 1601.

Email to be evaluated is email stored in the metadata DB 135 (see FIG. 8) on the email archive server 107. Files to be evaluated are files stored in the metadata DB 145 (FIG. 9) on the NAS archive server 118.

Such emails are dropped off from the evaluation target among the data of the email of FIG. 8 as the result of the file search process (step S1204 of FIG. 12) that there are no corresponding files on NAS whose contents are the same as the emails. Therefore, email evaluated in the importance calculation process includes email with the following attached file names in FIG. 8: file1, file4, file5, file6, file7, file8, and file9. Among these, FIG. 17 only lists email with attached files file1, file5, file6, file7, and file8.

A specific evaluation related to a first case 1702 of FIG. 17 will be described. The evaluation formula related to the email archive server is as follows:

R(t, tf, s)=a0*T(t)+a1*T(tf)

+a2*M+a3*S(s)

(* means the multiplication operator.)

Here, t, tf, and s denote variables of the evaluation function for calculation of the metadata of the email. The variable t denotes transmission time of email, tf denotes modification time of the file attached to the email, and s denotes sender. The definition of T(x) in the evaluation formula is as follows.

T(x)=exp{−alpha(tc−x)}, where alpha=ln2/(half year)=0.0038

As described, the function T(x) indicates that the value exponentially lowers over time. The unit of the time x is the number of days, and the halved period is a half year. The symbol tc denotes the current time. Therefore, tc−x denotes the number of days from the time x until now. The values of parameters are a0=5, a1=5, a2=20, and a3=10.

The evaluation formula related to the NAS archive server is as follows.

R(t)=a0*T(t)+a1*M

Here, R(t) denotes the evaluation value of the metadata of file, and t denotes the modification time of file. The values of parameters are a0=5 and a1=15. In reality, R(t, tf, s) and R(t) are multiplied by normalizing constants for evaluation. The constant is ¼ in the case of R(t, tf, s) so that the evaluation value is 0 to 10. The constant is ½ in the case of R(t).

As for the email archive server, the values of the metadata are evaluated to evaluate the email M0015. The values of the metadata used for the evaluation are acquired from the email archive server when the event is received and are equivalent to the contents of the metadata DB 135 (see FIG. 8) of the email archive server 107.

In the case 1702, tc=08/12/2, t=07/10/10, tf=07/10/1, and s=A@xyz, so that tc−t=428 and tf−t=419. Therefore, this is used to evaluate T(x). The symbol M is obtained by referring to the information of the metadata, and referring to the metadata associated with the email M0015, the email is on the archive storage. Therefore, M=1.

The LDAP server 101 is queried to evaluate S(s). A function for storing past LDAP data is incorporated in a metadata extraction function 102 in the LDAP server 101 of the present embodiment. In the present query, the transmission time is specified along with the email address s of the sender of the evaluation target. In this case, s=A@xyz, and the transmission time is 07/10/10. In response to the query, the LDAP server returns the job position of A@xyz at the time of the transmission time. In this case, the job position is regular employee, and the evaluation value of S(s) is 0. The values are combined, and eventually, R(t, tf, s)=0.50.

As for the NAS archive server 118, the file F0012 (file1) is evaluated in the same way, and the evaluation value R(t)=0.49 is obtained.

The evaluation results of FIG. 17 correspond to the following use cases. Hereinafter, the evaluation content of each use case will be described. The assumption in the evaluation formula herein is as follows. The current time is Dec. 2, 2007, and the time that the value is halved is a half year, or 182.5 days. The weights are a0=5, a1=5, a2=20, and a3=10 in the case of email, and a0=5 and a1=15 in the case of files. The archiving usually is performed when the value is halved.

(i) Old Active File

This is equivalent to the case 1 (1701) of FIG. 17. The email transmission date and the modification date of the attached file are more than half a year older than the current time, and the value is halved. The actual evaluation value of the email is 0.50, and the actual evaluation value of the file is 0.49. Considering that the evaluation values are 0 to 10, both evaluations result in low evaluations.

(ii) Data Remains Only on the NAS

This is equivalent to the case 2 (1702) of FIG. 17. That is, in the case, the data is left only on the NAS. The case is equivalent to when, for example, the email archive server determines that the value of the email is low based on the subject and the sender of the email and performs archiving before the value is temporally halved. In this case, the evaluation in email is 2.01, and the evaluation in file is 9.48.

(iii) File on the NAS is Accidentally Updated

This is equivalent to a case 3 (1703) of FIG. 17. In the case, the original update date is more than a half year older, and the files archived to the archive storage are accidentally updated. Usually, the archived files can be accessed by the links from the NAS, and the files are again returned to the NAS when accessed. The modification time of the file is renewed to Dec. 1, 2008. In this case, the evaluation of the email is 0.50, which is low, but the evaluation of the NAS is 9.99, which is high.

(iv) Old Email is Forwarded

This is equivalent to a case 4 (1704) of FIG. 17. That is, in the case, old email with attached file is forwarded. After the old email is referenced, the referenced email is returned from the archive storage to the email server. As a result, the evaluation of email is 6.49, and the evaluation of file is 0.49.

(v) Email from Unimportant Sender

This is equivalent to a case 5 (1705) of FIG. 17. Thus, in the case, email has arrived from an unimportant sender. The evaluation of email is 7.48, and the evaluation of file is 9.48. Since the value of the email can be evaluated by the metadata, sender which does not exist in the metadata of a file, the different evaluation values are obtained.

<Details of Importance DB>

Details of the importance DB 111 in the present embodiment will be described using FIG. 13. The importance DB 111 stores information of importance, which is evaluated by the importance calculating unit 110, of resources managed by the archive servers.

The importance DB 111 is constituted by fields of an object 1301 indicating IDs of resources in which the importance is calculated, an object type 1302 indicating the types of the resources, an evaluation 1303 indicating the evaluation results, an evaluation time 1304 indicating the time of the evaluations, a related object 1305 indicating objects related to the objects shown in 1301, and associated metadata 1307. If there are a plurality of related objects, the related objects are added to other related objects field 1306.

In the case of email, the related objects indicate attached files. For example, the row in the importance DB of FIG. 13, in which the object is M0015, indicates that the file1 attached to the email having the ID M0015 is registered as a related object. Detail information of the related object is written in another row. For example, as for the file1, an object is written in the row of F0012.

<Evaluation Result Display Screen>

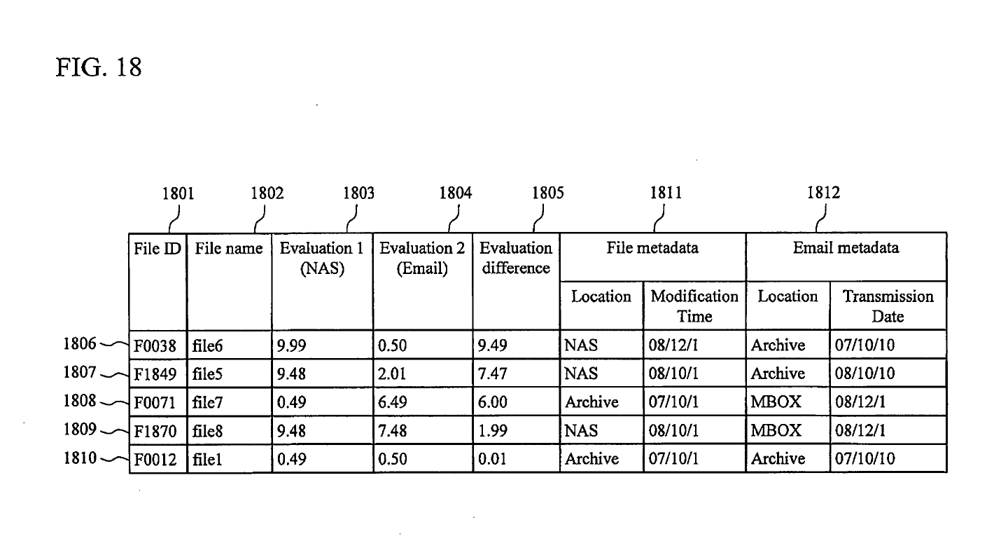

FIG. 18 is a diagram of an evaluation result display screen in the important file presenting unit 112. Evaluation results of files are displayed here. An object of the display is to allow a system administrator to determine whether the files are arranged on appropriate storages. Therefore, as shown in FIG. 18, a file ID 1801, a file name 1802, an evaluation 1 (1803) as an evaluation value of file, an evaluation 2 (1804) as an evaluation value of email, an evaluation difference 1805 that is a difference between the evaluation values, and a location 1811 as a storage location of file are displayed as information of the files.

In response to a request from the system administrator, the important file presenting unit 112 displays the evaluation results on a display screen of a display device (not shown) of a management computer. The system administrator specifies the type of data to be focused. The data types include file, email, document, and the like. The evaluation results are acquired from the importance DB 111. The acquired evaluations are assembled for each specified data type and are lined up in descending order of evaluation differences. A large evaluation difference indicates that the difference of evaluations by the archive servers is large. Therefore, a file with large difference is a possible target of archiving.

In FIG. 18, in the first row 1606, the evaluation in the file (NAS) related to the file name file6 is 9.99, while the evaluation in the email is 0.50, and the difference is 9.49. This implies that the file6 is highly evaluated in the NAS but receives a low evaluation as email, and one of the evaluations may be wrong. As shown in FIG. 18, the important file presenting unit 112 presents the files in descending order of evaluation differences. Therefore, the system administrator searches the files in descending order of differences and examines metadata displayed on the evaluation result display screen along with the files to eventually determine whether to archive the files. In the evaluation result display screen, difference values greater than a predetermined threshold may be displayed with a different color to draw attention of the administrator.

The system administrator can further check the evaluation results, related metadata, original data (files and email), and the like to adjust the evaluation formula. For example, the evaluation formula of email is as follows.

R(t, tf, s)=a0*T(t)+a1*T(tf)

+a2*M+a3*S(s),

a0=5, a1=5, a2=20, and a3=10

In the setting of the parameters, the fact of being archived is most heavily evaluated, followed by sender, transmission time, and modification time of attached file. The system administrator looks at the presented results to adjust parameters and parameter values to conform to the current status and the overall operation policy. Since the sender is evaluated heavier than the fact of being archived in the present example, if parameter values are changed to a2=10 and a3=20, the evaluation value in the email is 5.23, and the evaluation value in the NAS is 9.48 in a use case 5 (1705). The difference in the evaluation values is changed from 1.99, which is the difference before changing the parameter values, to 4.24. This indicates that the necessity for the administrator to check the circumstances of the use case 5 has increased.

Determination examples of the system administrator will be described in accordance with the use cases. The system administrator determines a management method of files based on the amount of the evaluation difference. Usually, a certain threshold is set, and files with differences exceeding the threshold are examined to determine the management method. In this case, the threshold is set to 5 (intermediate value).

(i) Files on the NAS are Accidentally Updated

This is equivalent to the case of the first row 1806 of FIG. 18. In this case, the system administrator checks that the evaluation difference 9.49 is greater than the threshold 5 and determines to perform an examination.

The system administrator then checks that the file modification time 08/12/1 is closer to the current time than the transmission time 07/10/10 of email attached with that file. Since this is usually impossible, the administrator accesses details of information of the email and checks that the attached file modification time of the email M0018 is 07/10/1 (see FIG. 8). As a result, the system administrator determines that the file file6 is accidentally modified (once modified, the modification is canceled, and stored).

(ii) Data Remains Only on the NAS

This is equivalent to the case of a row 1807 of FIG. 18. In this case, the system administrator checks that the evaluation difference 7.47 is greater than the threshold 5 and determines to perform an examination. The system administrator also checks the file modification time 08/10/1 and the email transmission time 08/10/10 and confirms both of the time differences from the current time are smaller than the half year, or a value halved period.

On the other hand, the system administrator determines that the email is archived by a factor other than the time because only the email is archived.

Lastly, the system administrator checks the content of the file and determines whether to archive the file.

(iii) Old Email is Forwarded

This is equivalent to the case of a row 1808 of FIG. 18. In this case, the system administrator checks that the evaluation difference 6.00 is greater than the threshold 5 and determines to perform an examination. The system administrator checks the email transmission time 08/12/1 and the file modification time 07/10/1.

The system administrator further checks details of the metadata of the email and checks that the modification time of the file attached to the email is 07/10/1. The system administrator checks that the modification times of those two files are the same and determines that the old email is forwarded and then again moved from the archive to the mail server.

Lastly, the system administrator determines the importance of the email and determines whether to archive the email again.

(iv) Email from Unimportant Sender

This is equivalent to a row 1609 of FIG. 18. In this case, the system administrator checks that the evaluation difference 1.99 is smaller than the threshold 5. The system administrator may determine to leave it untouched or to perform an examination.

To perform an examination, the system administrator checks that the evaluation of the email is low and checks the details of the metadata of the email. The system administrator checks the job position of the sender H@xyz from the LDAP server based on the configuration of the evaluation formula. The system administrator also checks that the job position of the sender is lower than general manager and determines that the evaluation of the email is based on the evaluation of the sender.

Lastly, the system administrator checks the content of the email and determines whether to archive the email and the file.

(v) Old Active File

This is equivalent to a row 1810 of FIG. 18. In this case, the system administrator checks that the evaluation difference 0.01 is smaller than the threshold 5. The system administrator also determines that the file and the email are evaluated in the same way and usually does not examine the present file.

In this way, the system administrator checks the metadata related to the evaluation values presented by the management computer. As a result, the system administrator can find out data archived in one archive server and not archived in another archive server and instruct archiving of the data that is not archived, if necessary.

Furthermore, according to the embodiment of the present invention, the management computer 108 presents data necessary to be checked in relation to archiving. Therefore, the system administrator can save the effort of checking all data. This is useful for reducing the entire management cost.

<Modified Examples>

In the first embodiment, a modification can be made as follows to deal with a case in which a plurality of attached files are attached to the email.

When the metadata related to the email is acquired and stored in the metadata DB 135 in the metadata filtering process, the same number of records (rows) as the number of attached files are created in the email (see FIG. 8). The same values as those of the previous example are inputted to the metadata (ID 801, sender 803, transmission time 804, attached file 805, and email storage location 808) other than the metadata related to the attached file, and values related to each attached file are inputted to the metadata (hint 802, attached file name 806, and attached file modification time 807) related to the attached files. In FIG. 8, two files (with file names file2 and file9) are attached to email M1235. Information of all attached files is transmitted as a file list during the evaluation in the importance calculating unit 110 (see FIG. 12). Therefore, in relation to the email M1235, information of both file2 and file9 is transmitted to the importance calculating unit 110 as a file list.

Furthermore, in the first embodiment, although there are only two archive servers, the email archive server 107 and the NAS archive server 118, the same processes can be basically applied even if there are a plurality of archive servers. For example, it is assumed herein that a document management archive server that moves data of a document management server to the archive storage 119 is connected, in addition to the two archive servers. In this case, the calculation method of the evaluation differences (1805 of FIG. 18) needs to be changed when the important file presenting unit 112 presents the evaluation values of file. As for the metadata corresponding to the data types used to evaluate the files, document metadata managed by the document management server needs to be added in addition to the file metadata 1811 and the email metadata 1812.

There are only two archive servers in the first embodiment. Therefore, there are only two evaluation values related to the files, and an absolute value of the difference between two evaluation values can be used as an evaluation difference.

However, the evaluation is not possible with only the absolute value of the difference if there are three or more archive servers. In that case, variance of three or more data is used as the evaluation difference. Three evaluation values are calculated for the files in the importance calculating unit 110 when there are the NAS archive server, the email archive server, and the document management archive server as in the example above.

Assuming that the evaluation values are Rn, Rm, and Rd, an average value M=(Rn+Rm+Rd)/3 of the evaluation values is calculated. At the same time, the variance D is defined as follows: D=[(Rn−M)²+(Rm−M)²+(Rd−M)²]/3.

The suitability of the archives can be determined by whether the absolute value of the difference between the average value of the evaluation values and the individual evaluation value is greater than a predetermined threshold. This is equivalent to the determination of whether the absolute values of the evaluation differences are greater than a predetermined threshold (in the case of the first embodiment) and is equivalent to considering the dispersion (variance) of the evaluation values.

### (2) Second Embodiment

A second embodiment relates to an example of associating (collaborating) the importance evaluation and the hierarchical storage management. The storage managed in the hierarchical storage management includes an archive storage. That is, the archive storage is considered as one level.

<System Configuration>

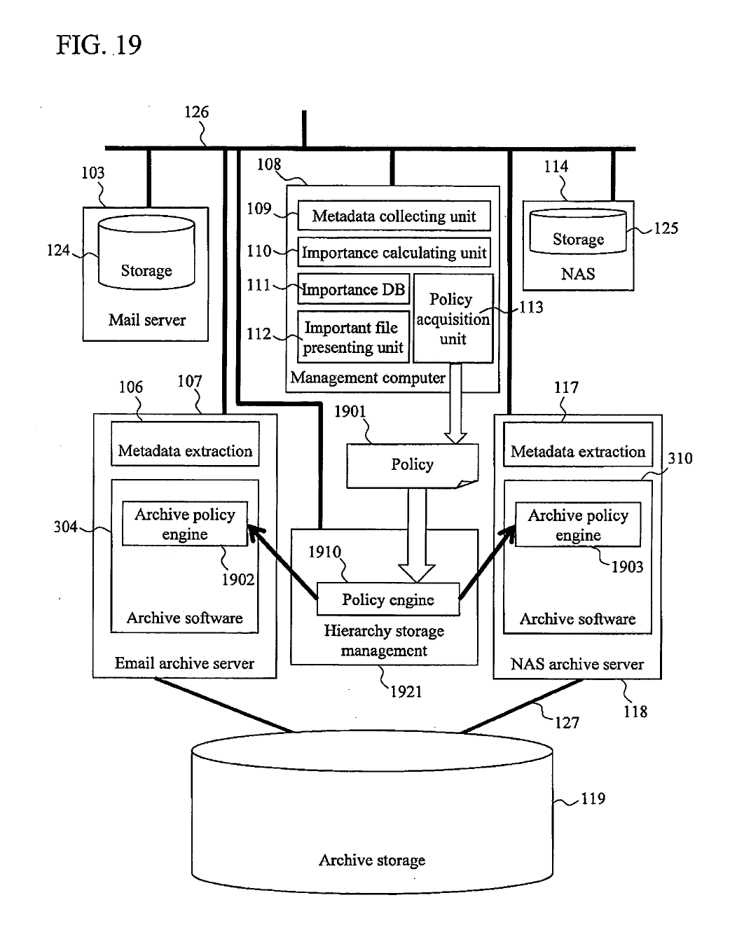

FIG. 19 is a diagram of a schematic configuration of a data classification processing system (data processing system) according to the second embodiment. Since the basic configuration is the same as in FIG. 1, only the differences from FIG. 1 will be described.

Reference numeral 1921 denotes a management server that performs hierarchical storage management. In FIG. 19, although the hierarchical storage management is operated on a server different from the management computer 108, the operation on the same server as the management computer is also possible. The hierarchical storage management 1921 includes a policy engine 1910. The policy engine 1910 receives a policy 1901 acquired by the policy acquisition unit 113 of the management computer 108.

Archive software 304 and 310 exist in the archive servers 107 and 118, respectively. The archive software 304 and 310 include archive policy engines 1902 and 1903, respectively, and archiving can be externally controlled through the policy engine 1910.

The hierarchical storage management 1921 and the importance evaluation are associated as follows. After the importance calculation of all files, the importance calculating unit 110 of the management computer 108 requests policy acquisition to the policy acquisition unit 113.

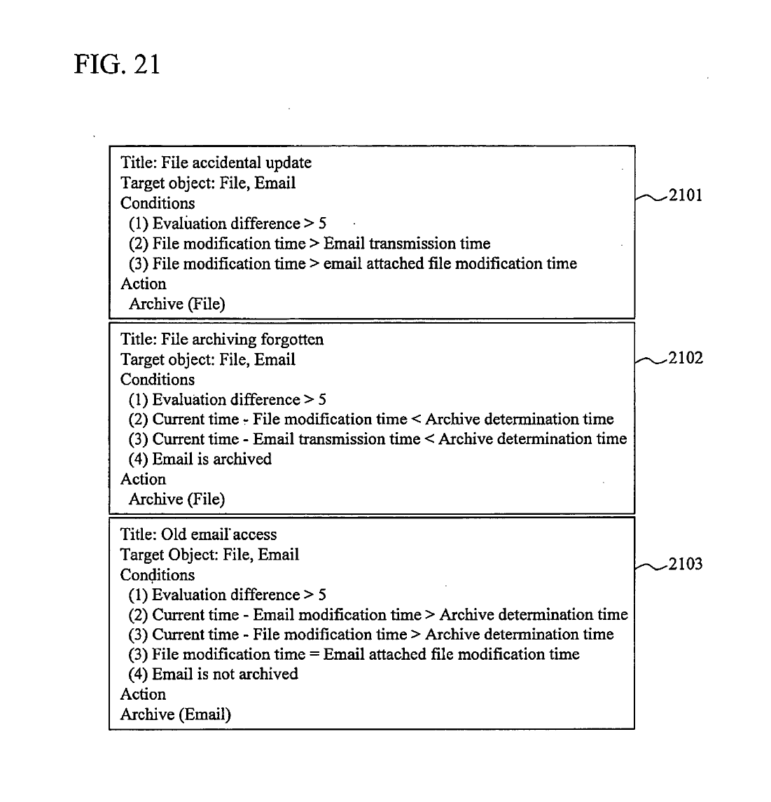

The policy acquisition unit 113 transmits a hierarchical storage management policy (control policy) generated based on the importance DB 111 calculated by the importance calculating unit 110 to the policy engine 1910. The policy is a rule indicating that an action is executed when conditions of the management object are satisfied. The policy acquisition unit 113 stores a plurality of policies generated in advance in accordance with various situations. Specific contents of the policy will be described below (see FIG. 21).

<Relationship Between Importance Calculation and Policy Acquisition>

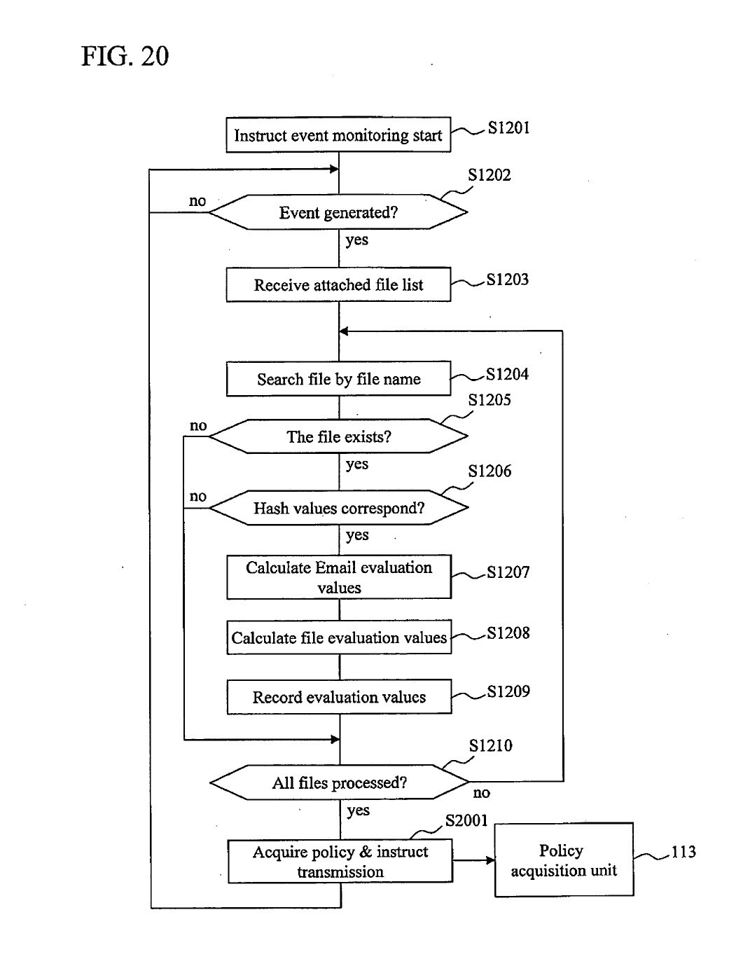

FIG. 20 is a flow chart for explaining details of the collaboration of the importance calculating unit 110 and the policy acquisition unit 113. In FIG. 20, steps S1201 to S1210 are the same as the processes of the importance calculation described in the first embodiment, and the description will not be repeated. In the present embodiment, in addition to the processes, the importance calculating unit 110 instructs the policy acquisition unit 113 to acquire a policy and transmit the policy to the policy engine after the importance calculation process (step S2001).

<Specific Examples of Policy>

FIG. 21 is a diagram of examples of policies stored by the policy acquisition unit 113 and transmitted to the policy engine 1910. The policies shown in FIG. 21 are only examples and are not limited to these. Obviously, polices in other forms can be considered. These policies describe operations performed by the system administrator based on the evaluation results presented by the important file presenting unit 112. In the present embodiment, an action described in an action section is automatically performed if all conditions shown in a condition section are satisfied.

A policy 2101 is a policy equivalent to the use case 3 described in the first embodiment, in which a file on the NAS is accidentally adjusted. A policy is constituted by a condition section and an action section. The condition section describes conditions for the policy to be invoked. The action section indicates an operation performed in the policy.

There are three conditions in the condition section of the policy 2101. A condition 2101 (1) indicates that the evaluation difference obtained by the importance calculating unit 110 is greater than the threshold 5. A condition 2101(2) indicates that the modification time of file is later than the email transmission time. A condition 2101(3) indicates that the modification time of file is later than the modification time of file attached to email. The action section is executed when all conditions are satisfied. The condition 2101 is equivalent to a check item performed by the system administrator when the file is accidentally updated on the NAS in the first embodiment. Thus, checking that the evaluation difference is greater than the threshold 5 is equivalent to the condition 2101(1), checking that the modification time of file is closer to now than the transmission time of email attached with the file is equivalent to the condition 2101(2), and checking the modification time of the attached file of the email is equivalent to the condition 2101(3).

The policy 2102 is a policy equivalent to the use case 2 described in the first embodiment, in which the file archiving is forgotten. A condition 2102(1) indicates that the evaluation difference obtained by the importance calculating unit 110 is greater than the threshold 5. A condition 2102(2) indicates that the difference between the modification time of file and the current time is smaller than the archive determination time, which is a threshold for archiving the file. A condition 2102(3) indicates that the difference between the transmission time of email and the current time is smaller than the archive determination time. A condition 2102(4) indicates whether the email is archived. In the policy, the file is archived when the conditions in the condition section are satisfied.

A policy 2103 is a policy equivalent to the use case 4 described in the first embodiment 1, in which old email is accessed. A condition 2103(1) indicates that the evaluation difference obtained by the importance calculating unit 110 is greater than the threshold 5. A condition of 2103(2) indicates that the elapsed time from the transmission of email is longer than archive determination time. A condition of 2103(3) indicates that the elapsed time from the modification of file is longer than the archive determination time. A condition of 2103(4) indicates that the modification time of the file and the modification time of the attached file of the email are equal. A condition of 2103(5) indicates that the email is not archived. In the policy, the email is archived when the conditions of the condition section are satisfied.

<Processes of Policy Engine>

Processes executed for at least one policy acquired by the policy engine 1910 of the hierarchical storage management from the policy acquisition unit 113 will be described in detail.

The policy 2101 is transferred to the policy engine 1910 of the hierarchical storage management 1921 along with the content of the importance DB 111. The policy engine 1910 specifies the file F0038 (file6) and the email M0018 as target objects to execute the policy 2101. The policy engine 1910 first evaluates the condition section and uses the importance evaluation result of the file F0038 (file6) and the email M0018 to evaluate 2101(1). Specifically, the policy engine 1910 refers to the evaluation 1303 of the row, in which the object 1301 (see FIG. 13) of the importance DB 111 is M0018, and of the row of F0038 to calculate the absolute value of the difference of the evaluations. The policy engine 1910 compares the difference 9.45 and the threshold 5, and evaluates that the condition 2101(1) is true.

Since the condition 2101(1) is true, the policy engine 1910 proceeds to the evaluation of the next condition 2101(2). As with 2101(1), the policy engine 1910 refers to the importance DB 111 and acquires the modification time 08/12/1 from the metadata 1307 of the file F0038 (file6) and the transmission time 07/10/10 from the metadata 1307 of the email M0018. Based on the acquired values, the policy engine 1910 determines that the file modification time>the email transmission time and evaluates that the condition 2101(2) is true.

Since the condition 2101(2) is true, the policy engine 1910 evaluates the next condition 2101(3). The policy engine 1910 refers to the importance DB 111 and acquires the modification time 08/12/1 from the metadata 1307 of the file F0038 (file6) and the modification time 07/10/1 of the attached file from the metadata 1307 of the email M0018. Based on the acquired values, the policy engine 1910 determines that the file modification time>the email attached file modification time and evaluates that the condition 2101(3) is true.

All conditions of the condition section are evaluated, and all conditions are true. Therefore, the policy engine 1910 executes the action of the action section. Since “ARCHIVE (FILE)” is written in the action section, the policy engine 1910 requests the archive policy engine 1903 in the archive software 310 of the NAS archive server 118 to archive the file F0038 (file6).

The policy engine 1910 evaluates the policies 2102 and 2103 in the same way, and if all conditions written in the condition section are satisfied, the policy engine 1910 executes the action of the action section and executes the archive operation. The policy engine 1910 of the hierarchical storage management 1921 executes archiving of file for the policy 2102 as well as 2101 and archiving of email for 2103.

In this way, the use of the evaluation values of the importance calculating unit 110 can simplify the description of the policy, and an automatic archive process can be realized. Therefore, the operation of the system administrator is reduced by the policy. Although the action described in the action section is automatically executed when all conditions described in the condition section of the policy are satisfied, the action may just be presented to the system administrator to prompt the execution of the action when all conditions are satisfied. Even with this configuration, the system administrator does not have to determine what to do based on the importance evaluation values and the metadata, and the burden of the system administrator can be reduced.

### (3) Third Embodiment

In the first embodiment, the archive servers 107 and 118 store metadata based on preset criteria, and when a monitoring event is generated based on preset conditions, the stored metadata is aggregated to the management computer 108 to calculate the importance on the management computer. In a third embodiment, the importance calculating unit is dispersed to the archive servers, and the management computer 108 collects only the calculation results.

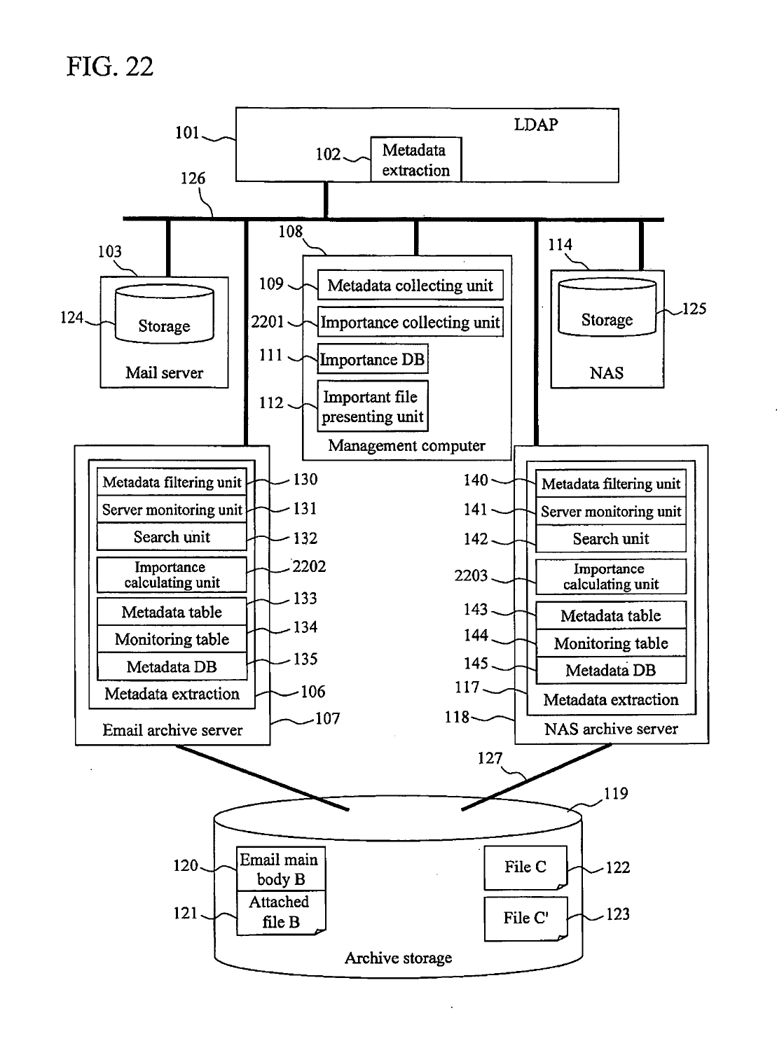

FIG. 22 is a diagram of a schematic configuration of a data classification processing system (data processing system) according to the third embodiment. Since the basic configuration is the same as FIG. 1, only the differences from FIG. 1 will be described.

The management computer 108 comprises an importance collecting unit 2201 that collects the calculation results in place of the importance calculating unit 110 of the first embodiment. The archive servers comprise importance calculating units 2202 and 2203.

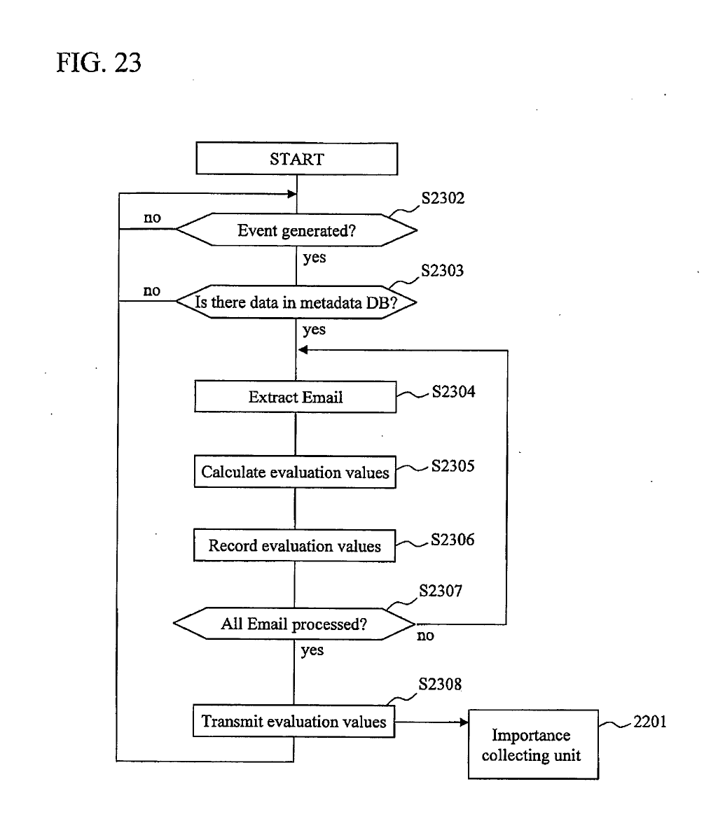

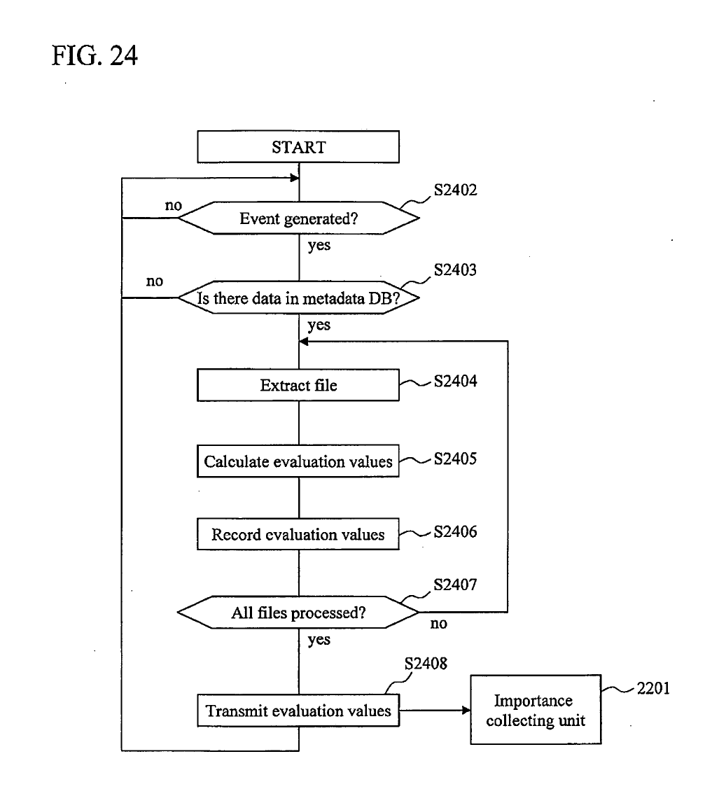

The processes of filter setting and monitor setting by the metadata collecting unit 109 of the management computer 108 are the same as in the first embodiment. The monitoring operations in the archive servers are greatly different from the first embodiment. The monitoring operations will be described in detail using FIGS. 23 and 24.

FIG. 23 is a flow chart for explaining a monitoring operation in the email archive server 107 according to the third embodiment. The monitoring operation starts when the email archive server is activated, and after the start, the existence of event generated by the email server is checked. The events to be monitored are written in the email monitoring table 134 set in the monitoring setting process. In the present embodiment, the monitoring unit 2202 monitors events related to archiving, storage capacity, and monitoring interval (see FIG. 5). Specifically, in relation to the archiving, the monitoring unit 2202 monitors whether email is moved to the archive storage 119. In relation to the storage capacity, the monitoring unit 2202 monitors whether the email storage capacity on the email server has exceeded 80% of the capacity. In relation to the monitoring interval, the monitoring unit 2202 monitors whether three days (monitoring interval) has passed since the last event occurrence. If any one of the monitoring conditions is satisfied, an event is generated.

The server monitoring unit 131 checks the generation of event (step S2302). If the event is generated, the process moves to step S2303. If the event is not generated, the server monitoring unit 131 continues to monitor the generation of event.

When the event is generated, the importance calculating unit 2202 accesses the metadata DB 135 and checks whether there is metadata associated with an email in DB (step S2303). If there is no email metadata stored in DB (data is in the metadata DB), the process returns to the event generation standby state (step S2302). If there is stored email metadata, the importance calculating unit 2202 acquires information of metadata associated with the email (step S2304). For example, if the information shown in FIG. 8 is registered in the metadata DB 135, the values of corresponding metadata are acquired in order from the leading email M0015, A@xyz as the sender, 07/10/10 as the transmission time, 07/10/1 as the attached file name modification, and archive as the email storage location.

The importance calculating unit 2202 then uses the values of the metadata acquired in step S2304 to calculate the evaluation value of the email based on the evaluation formula specified in advance (step S2305). The importance calculating unit 2202 temporarily records the calculated value to a memory not shown (step S2306). The importance calculating unit 2202 further checks whether the process is finished for all email (step S2307), and if email to be processed remains, the process returns to step S2304, and the evaluation value calculation by the importance calculating unit 2202 continues.

If the evaluation is completed for all email, the importance calculating unit 2202 transmits all evaluation values temporarily recorded in step S2306 to the importance collecting unit 2201 of the management computer 108 in step S2306 (step S2308). The calculation method of specific evaluation values is the same as in the first embodiment and will not be repeated.

FIG. 24 is a flow chart for explaining a monitoring operation in the NAS archive server 118. The monitoring operation starts when the NAS archive server is activated, and after the start, the existence of the event generated by the server (NAS) is checked. The event to be monitored is written in the NAS monitoring table 144 set upon the monitor setting process. In the present embodiment, the server monitoring unit 141 monitors events related to archiving, storage capacity, and monitoring interval (see FIG. 7). Specifically, in relation to the archiving, whether the file is moved to the archive storage is monitored. In relation to the storage capacity, whether the file storage capacity on the NAS has exceeded 80% of the capacity is monitored. In relation to the monitoring interval, whether three days (monitoring interval) has passed from the last event occurrence is monitored. An event is generated if any one of the monitoring condition is satisfied.

The server monitoring unit 141 checks the generation of event (step S2402), and the process moves to step S2403 if the event is generated. Otherwise, the server monitoring unit 141 continues to monitor the generation of event. When the event is generated, the importance calculating unit 2203 accesses the metadata DB 145 to check whether there is metadata associated with a file stored in DB (step S2403). If there is no file metadata, the process returns to the event generation standby state. If there is a file metadata, the importance calculating unit 2203 acquires information of metadata associated to the file (step S2404).

The importance calculating unit 2203 then uses the values of the metadata acquired in step S2404 to calculate the evaluation values of the file based on the evaluation formula specified in advance (step S2405) and temporarily records the calculated values in the memory not shown (step S2406).

The importance calculating unit 2203 checks whether the process is completed for all files (step S2407). If a file to be processed remains, the process returns to step S2404, and the evaluation value calculation is continued. When the evaluation is completed for all files, the importance calculating unit 2203 transmits all evaluation values temporarily recorded in step S2406 to the importance collecting unit 2201 of the management computer 108 (step S2408). The calculation method of specific evaluation values is the same as in the first embodiment and will not be repeated.

### (4) CONCLUSION

Although the processes by the combination of the email server and the NAS have been described in the embodiments, the present invention is not limited to this combination. The present invention can also be applied to processes by the combination of a content management server or a document management server and the NAS, or other combinations.

In the present invention, the archive management devices and the hierarchical storage management devices that manage the data of various data types collaborate and share archive determination and data movement determination criteria in a certain device. The data determined to be archived or moved in a certain archive management device or hierarchical storage management device is also archived or moved in other archive management devices or hierarchical storage management devices. As a result, efficient storage management is possible in the entire system.

In the present invention, information of metadata is taken up from the archive management devices or hierarchical storage management devices to extract data that would be archived or subjected to the hierarchical storage management from the entire system. As a result, the system administrator can reduce the management cost of checking all files. Furthermore, a uniform management standard can be applied to the entire system.

More specifically, the email server (103) and the NAS (114) manage correlated data such as email data in the email server (103) and file data attached to the email stored in the NAS (114). The email archive server and the NAS archive server (107 and 118) extract email and attached files that satisfy predetermined filter conditions from the email server and the NAS, respectively, and inform the management computer (108). The management computer (108) associates the data of the email and attached files and manages the data as data to be moved to the archive storage (119). In this way, the associated files for management can be extracted, and the data can be efficiently managed by the association of management.

The server monitoring units (131 and 141) monitor the generation of a predetermined event (such as movement to the archive or passage of time) related to corresponding email and attached files correlated to the email. The detection of the event generation starts the associated management process. When the email server and/or the NAS detect the generation of the predetermined event, evaluation values of the extracted email and attached files are calculated based on a predetermined evaluation function (see FIGS. 14 and 16) at least including a time value evaluation. Furthermore, the important file presenting unit (112) compares and presents the evaluation values calculated for the correlated email and its attached files. As a result, the administrator can recognize that the data which should be managed in the same level are managed in different levels and quickly deal with it. Therefore, the management cost by the administrator can be reduced. Furthermore, even if the data that should be managed in an archive storage remains on the server, the data can be returned to the archive storage. Therefore, the cost for the storage can also be reduced (thus, the price per bit is inexpensive in the archive storage than in the server).

If the difference of evaluation values of the email data and the file data stored in the email server and the NAS from an average value of the evaluation values of the data is greater than a predetermined absolute value (threshold) (when the difference between the evaluation values of two servers are greater than the predetermined value if there are two servers), the evaluation is presented to draw attention (for example, presented in descending order of difference, or the display color of the data greater than the threshold is varied from others). If there is a difference greater than the predetermined threshold, it is likely that the email and the attached file are managed in different storage levels (one is on the server, and the other is on the archive storage). In this way, a set of data (email and attached file) that is likely to be inefficiently managed can be easily discovered.

In the second embodiment, in addition to the system configuration of the first embodiment, the policy engine (1910) is further arranged that executes policies (a plurality of policies are prepared) including condition sections describing conditions and action sections describing actions that should be executed when the conditions are satisfied. The policy engine (1910) compares predetermined metadata and evaluation values with the policies for each set of email and attached file and controls the archive servers (107 and 118) to execute the actions if all conditions are satisfied. In this way, a problematic set of data can be discovered, and the data can be managed in an appropriate storage level without making the administrator execute the process of comparing the evaluation values.

If the LDAP server that manages the user is connected to the network and the LDAP server records past organization information, the job position of the user corresponding to the time is acquired in response to the job position request transmitted after the designation of the email ID of user and the time. If the sender is designated as the metadata to the evaluation formula related to email, the importance calculating unit specifies the email ID of the sender and the transmission time of the email for the LDAP server, transmits the job position request, and makes an evaluation based on the obtained job position. As a result, an evaluation factor other than the temporal value of data can be included.

The present invention can also be realized by a program code of software for realizing functions of the embodiments. In that case, a storage medium recording the program code is provided to a system or a device, and a computer (or CPU or MPU) of the system or the device reads out the program code stored in the storage medium. In that case, the program code read out from the storage medium realizes the functions of the embodiments, and the program code and the storage medium recording the program code constitute the present invention. Examples of the storage medium for supplying the program code includes a flexible disk, a CD-ROM, a DVD-ROM, a hard disk, an optical disk, a magneto-optical disk, a CD-R, a magnetic tape, a non-volatile memory card, and a ROM.

An OS (operating system) or the like operated on the computer may execute part or all of the actual processes based on an instruction of the program code, and the processes may realize the functions of the embodiments. Furthermore, after the program code read out from the storage medium is written into a memory of the computer, the CPU or the like of the computer may execute part or all of the actual processes based on an instruction of the program code, and the processes may realize the functions of the embodiments.

The program code of the software for realizing the functions of the embodiments may be distributed through a network and stored in storage means, such as a hard disk and a memory of the system or the device, or in a storage medium, such as a CD-RW and a CD-R, and the computer (or CPU or MPU) of the system or the device may read out the program code stored in the storage means or the storage medium and execute the program code upon use.

1. A data processing system comprising:
a plurality of data servers (103, 114);
a storage device (119) that aggregates and stores data stored in the plurality of data servers;
a plurality of data migration devices (107, 118) that are arranged corresponding to the plurality of data servers (103, 114) and that move the data stored in the respective data servers (103, 114) to the storage device (119); and
a management computer (108) that controls the plurality of data migration devices (107, 118) and that manages the movement of the data from the plurality of data servers (103, 114) to the storage device (119), wherein
the plurality of data servers (103, 114) include data at least partially having a predetermined correlation among a plurality of types of data stored in the plurality of data servers (103, 114),
the plurality of data migration devices (107, 118) respectively include data extracting units (130, 140) that respectively extract data satisfying a predetermined filter condition from the plurality of data servers (103, 114) and that inform to the management computer (108), and
the management computer (108) manages the data that is extracted by the data extracting units (130, 140) and that is respectively stored in the plurality of data servers (103, 114) as data to be associated and moved to the storage device (119).

2. The data processing system according to claim 1, wherein
the plurality of data servers include an email server (103) that manages email and a file server (114) that manages an attached file attached to the email,
the storage device is an archive storage (119),
the plurality of data migration devices include an email archive server (107) and a file archive server (118),
the storage device is an archive storage (119),
the email archive server (107) includes a first server monitoring unit (131) that monitors a predetermined event occurrence related to the email stored in the email server (103),
the file archive server (118) includes a second server monitoring unit (141) that monitors a predetermined event occurrence related to the attached file stored in the file server (114),
the management computer (108) further includes: an importance calculating unit (110) that calculates evaluation values of the email and the attached file extracted by the data extracting units (130, 140) based on a predetermined evaluation function at least including a time value evaluation when the first and second server monitoring units (131, 141) detect the predetermined event occurrence in one of the email server (103) and the file server (114); and
an information presenting unit (112) that compares and presents the evaluation values calculated by the importance calculating unit (110) in relation to the correlated data,
the data extracting units (130, 140) further extract predetermined metadata from the extracted email and attached file and stores the metadata in metadata DBs (135, 145),
the importance calculating unit (110) acquires the metadata corresponding to the extracted email and attached file from the metadata DBs (135, 145) when the predetermined event occurrence is detected and calculates the evaluation values for each set of the extracted email and the attached file attached to the email based on the predetermined evaluation function, and
the information presenting unit (112) presents the evaluation values to draw attention if the evaluation values related to the email stored in the email server (103) and the attached file that is stored in the file server (114) and that is attached to the email have a difference of more than a predetermined absolute value from an average value of the evaluation values.

3. The data processing system according to claim 2, further comprising
a policy engine (1910) that verifies a prepared policy including a condition section describing conditions and an action section describing an action executed when the conditions are satisfied, wherein
the policy engine (1910) compares the predetermined metadata and the evaluation values with the policy for each set of the email and the attached file and controls the email archive server (107) and the file archive server (118) to execute the action when all the conditions are satisfied.

4. The data processing system according to claim 1, wherein
the plurality of data migration devices (107, 114) respectively include server monitoring units (131, 141) that monitor a predetermined event occurrence related to data stored in corresponding data servers, and
the management computer (108) further includes: an importance calculating unit (110) that calculates evaluation values of data extracted by the data extracting units (130, 140) based on a predetermined evaluation function at least including a time value evaluation when the server monitoring units (131, 141) detect the predetermined event occurrence in one of the plurality of data servers; and
an information presenting unit (112) that compares and presents the evaluation values calculated by the importance calculating unit (110) in relation to the correlated data.

5. The data processing system according to claim 4, wherein
the data extracting units (130, 140) extract predetermined metadata from the extracted data and store the metadata in the metadata DBs (135, 145), and
the importance calculating unit (110) acquires the metadata corresponding to the extracted data from the metadata DB s (135, 145) when the predetermined event occurrence is detected and calculates the evaluation values for each of the extracted data based on the predetermined evaluation function.

6. The data processing system according to claim 4, wherein
the information presenting unit (112) presents the evaluation values to draw attention when the evaluation values of the data that is stored in the plurality of data servers and that includes a predetermined correlation have a difference of more than a predetermined absolute value from an average value of the evaluation values.

7. The data processing system according to claim 6, wherein
the fact that there is a difference of more than the predetermined absolute value from the average value of the evaluation values of the data between the evaluation values of the data including the predetermined correlation indicates that the data including the predetermined correlation are managed in different storage levels.

8. The data processing system according to claim 5, further comprising
a policy engine (1910) that verifies a prepared policy including a condition section describing conditions and an action section describing an action executed when the conditions are satisfied, wherein
the policy engine (1910) compares the predetermined metadata and the evaluation values with the policy for each of the data and controls the plurality of data migration devices (107, 118) to execute the action when all the conditions are satisfied.

9. A data processing method in a data processing system comprising:
a plurality of data servers (103, 114);
a storage device (119) that aggregates and stores data stored in the plurality of data servers;
a plurality of data migration devices (107, 118) that are arranged corresponding to the plurality of data servers (103, 114) and that move the data stored in the respective data servers (103, 114) to the storage device (119); and
a management computer (108) that controls the plurality of data migration devices (107, 118) and that manages the movement of the data from the plurality of data servers (103, 114) to the storage device (119), wherein
the plurality of data servers (103, 114) include data at least partially having a predetermined correlation among a plurality of types of data stored in the plurality of data servers (103, 114),
in the processing method,
data extracting units (130, 140) respectively included in the plurality of data migration devices (107, 140) respectively extract data satisfying predetermined filter conditions from the plurality of data servers (103, 114) and inform to the management computer (108), and
the management computer (108) manages the data that is extracted by the data extracting units (130, 140) and that is respectively stored in plurality of the data servers (103, 114) as data to be associated and moved to the storage device (119).

10. The data processing method according to claim 9, wherein
the plurality of data servers include an email server (103) that manages email and a file server (114) that manages an attached file attached to the email,
the storage device is an archive storage (119),
the plurality of data migration devices include an email archive server (107) and a file archive server (118),
the storage device is an archive storage (119),
the email archive server (107) includes a first server monitoring unit (131) that monitors a predetermined event occurrence related to the email stored in the email server (103),
the file archive server (118) includes a second server monitoring unit (141) that monitors a predetermined event occurrence related to the attached file stored in the file server (114),
in the processing method,
the data extracting units (130, 140) further extract predetermined metadata from the extracted email and attached file and stores the metadata in metadata DBs (135, 145),
an importance calculating unit (110) included in the management computer (108) acquires the metadata corresponding to the extracted email and attached file from the metadata DBs (135, 145) and calculates evaluation values of the email and the attached file extracted by the data extracting units (130, 140) based on a predetermined evaluation function including at least a time value evaluation when the first and second server monitoring units (131, 141) detect the predetermined event occurrence in one of the email server (103) and the file server (114), and an information presenting unit (112) included in the management computer (108) compares and presents the evaluation values calculated by the importance calculating unit (110) in relation to the correlated data and presents the evaluation values to draw attention if the evaluation values related to the email stored in the email server (103) and the attached file that is stored in the file server (114) and that is attached to the email have a difference of more than a predetermined absolute value from an average value of the evaluation values.

11. A program for a system comprising a plurality of computers to function as the data processing system according to claim 1.
